(19) United States
(12) Patent Application Publication
(10) Pub. No.: US 2023/0368290 A1
(43) Pub. Date: Nov. 16, 2023

(54) SYSTEMS AND METHODS FOR PAYMENT INSTRUMENT PRE-QUALIFICATION DETERMINATIONS

(71) Applicant: Synchrony Bank, Stamford, CT (US)

(72) Inventors: Gregg Peters, Stamford, CT (US); Falko Kloepper, Stamford, CT (US); Patrick Gamgort, Stamford, CT (US)

(21) Appl. No.: 18/315,017

(22) Filed: May 10, 2023

Related U.S. Application Data
(60) Provisional application No. 63/341,151, filed on May 12, 2022.

(51) Int. Cl. G06Q 40/03; G06Q 30/0226

(52) U.S. Cl. CPC G06Q 40/03; G06Q 30/0232

(57) ABSTRACT

Systems and methods for automatic and dynamic pre-qualification determinations associated with secured and unsecured payment instruments are provided. The systems and methods are used to automatically generate and provide pre-qualification determinations for different payment instruments based on various factors. The systems and methods further provide these pre-qualification determinations along with any applicable terms and conditions corresponding to the payment instruments a user is pre-qualified for.

### CROSS-REFERENCE TO RELATED APPLICATIONS

The present patent application claims the priority benefit of U.S. Provisional Patent Application No. 63/341,151 filed May 12, 2022, the disclosures of which are incorporated by reference herein.

### FIELD

The present disclosure relates generally to automatic and dynamic pre-qualification determinations associated with secured and unsecured payment instruments. In one example, the systems and methods described herein may be used to automatically generate and provide pre-qualification determinations for different secured and unsecured payment instruments based on various factors. Further, the systems and methods described herein may automatically, and dynamically, provide pre-qualification determinations along with terms and conditions corresponding to approved secured and unsecured payment instrument accounts.

### SUMMARY

Disclosed embodiments may provide a framework for automatically and dynamically generating pre-qualification determinations associated with secured and unsecured payment instruments based on pre-qualification requests. According to some embodiments, a computer-implemented method is provided. The computer-implemented method comprises receiving a pre-qualification request associated with a user. The pre-qualification request includes information corresponding to the user. The computer-implemented method further comprises obtaining a credit evaluation corresponding to the user. The credit evaluation is obtained based on the information corresponding to the user. The computer-implemented method further comprises training a machine learning algorithm to identify a set of payment instruments that the user is pre-qualified for. The machine learning algorithm is trained using the information, the credit evaluation, historical data, and issued payment instruments. The computer-implemented method further comprises providing a set of offers corresponding to the set of payment instruments that the user is pre-qualified for. Further, the computer-implemented method comprises receiving an application for a payment instrument from the set of payment instruments. The application corresponds to a selection of an offer from the set of offers. The computer-implemented method further comprises updating the machine learning algorithm. The machine learning algorithm is updated using the set of offers, the selection of the offer from the set of offers, the historical data, and the issued payment instruments.

In some embodiments, the computer-implemented method further comprises determining that the user is approved for the payment instrument. The user is approved for the payment instrument based on the application and the credit evaluation. The computer-implemented method further comprises providing an alternative set of offers corresponding to other payment instruments. The alternative set of offers includes a set of incentives for selecting an offer from the alternative set of offers. Further, the set of incentives are determined based on the information corresponding to the user and the credit evaluation.

In some embodiments, the computer-implemented method further comprises submitting a soft credit inquiry to obtain the credit evaluation. The soft credit inquiry includes the information corresponding to the user.

In some embodiments, the computer-implemented method further comprises automatically tracking credit performances associated with the user and other users. The credit performances correspond to usage of the payment instrument and to usage of other payment instruments issued to the other users. Further, the credit performances are tracked in real-time. The computer-implemented method further comprises updating the machine learning algorithm using the credit performances.

In some embodiments, the set of offers include an offer corresponding to a secured dual-feature payment instrument. Further, the offer indicates a security deposit for the secured dual-feature payment instrument.

In some embodiments, the set of offers include details corresponding to benefits and terms associated with the set of payment instruments.

In some embodiments, the computer-implemented method further comprises receiving another application for an alternative payment instrument. The alternative payment instrument does not correspond to the set of offers. Further, the computer-implemented method comprises updating the machine learning algorithm using the other application for the alternative payment instrument.

In some embodiments, the historical data and the issued payment instruments correspond to the user.

In some embodiments, the historical data and the issued payment instruments correspond to other users.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which secured and unsecured payment instrument offers are automatically generated in response to pre-qualification requests and to submission of applications for a new line of credit associated with a secured or unsecured payment instrument in accordance with at least one embodiment;

FIG. 2 shows an illustrative example of an environment in which a pre-qualification system of a dual-feature payment instrument service automatically generates one or more payment instrument offers in response to a pre-qualification request in accordance with at least one embodiment;

FIG. 3 shows an illustrative example of an environment in which an offer generation algorithm processes results from a soft credit inquiry, transaction records, and data from previous applications for lines of credit associated with user accounts to identify and generate one or more payment instrument offers in accordance with at least one embodiment;

FIG. 4 shows an illustrative example of an environment in which a payment instrument application system of a dual-feature payment instrument service processes an application for a new line of credit and automatically generates new offers for other lines of credit associated with secured and unsecured payment instruments in accordance with at least one embodiment;

FIG. 5 shows an illustrative example of an environment in which an approval algorithm processes an application for a new line of credit, results from a full credit inquiry, and user records to automatically generate an approval determination and new offers for other lines of credit in accordance with at least one embodiment;

FIG. 6 shows an illustrative example of an environment in which a user is presented with a set of offers for different lines of credit associated with secured and unsecured payment instruments in response to a pre-qualification request in accordance with at least one embodiment;

FIG. 7 shows an illustrative example of an environment in which a user is presented with a set of terms corresponding to a new line of credit the user applied for and a set of offers for different lines of credit associated with secured and unsecured payment instruments in response to an application to establish the new line of credit in accordance with at least one embodiment;

FIG. 8 shows an illustrative example of a process for generating and providing one or more pre-qualification offers for lines of credit associated with secured and unsecured payment instruments in accordance with at least one embodiment;

FIG. 9 shows an illustrative example of a process for generating an application determination and new offers for other lines of credit associated with secured and unsecured payment instruments in accordance with at least one embodiment; and

FIG. 10 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for automatically and dynamically generating pre-qualification determinations associated with secured and unsecured payment instruments based on pre-qualification requests. For instance, in response to a pre-qualification request, the systems described herein may perform a soft credit inquiry to obtain a credit evaluation corresponding to the user that submitted the request. Using a trained machine learning algorithm of artificial intelligence, the credit evaluation may be processed in order to identify any secured and/or unsecured payment instruments that the user may be pre-qualified for. Further, the machine learning algorithm may identify any corresponding benefits and terms associated with these secured and/or unsecured payment instruments that may be presented to the user. The systems, based on the output of the machine learning algorithm or artificial intelligence, may present a set of offers corresponding to the secured and/or unsecured payment instruments the user is pre-qualified for, as well as any corresponding benefits and terms. If the user submits an application for a line of credit corresponding to a particular payment instrument, the systems may update the machine learning algorithm or artificial intelligence based on the user's selection of the particular payment instrument and historical data corresponding to other users to whom other offers for payment instruments previously provided to other users.

A secured dual-feature payment instrument may be a payment instrument associated with an account that is secured by a deposit provided by an account holder and held in escrow by the dual-feature payment instrument service. An unsecured dual-payment instrument may be a payment instrument associated with an account that is not secured by a deposit. Graduation of a secured dual-feature payment instrument to an unsecured dual-feature payment instrument may include converting the secured dual-feature payment instrument to an unsecured dual-feature payment instrument by, for example, returning the security deposit for the dual-feature payment instrument (including generating and providing one or more options for automatic disbursement of the security deposit), adjusting the credit limit of the dual-feature payment instrument, updating various credit reporting agencies of the graduation, and other such operations. Graduation of a secured dual-feature payment instrument to an unsecured dual-feature payment instrument may also be referred to herein as a promotion of a secured dual-feature payment instrument to an unsecured dual-feature payment instrument.

As used herein and unless otherwise made expressly clear, “promotion” of a secured dual-feature payment instrument to an unsecured dual-feature payment instrument refers to the systems and methods described herein for graduating a secured dual-feature payment instrument to an unsecured dual-feature payment instrument rather than the conventional meaning of “promotion” (e.g., offering an incentive to promote participation or engagement with services associated with the dual-feature payment instrument). Further, as used herein, a “dual-feature payment instrument” is a payment instrument that is initially secured by a deposit and that can be graduated to an unsecured payment instrument based on one or more criteria, as described in greater detail herein.

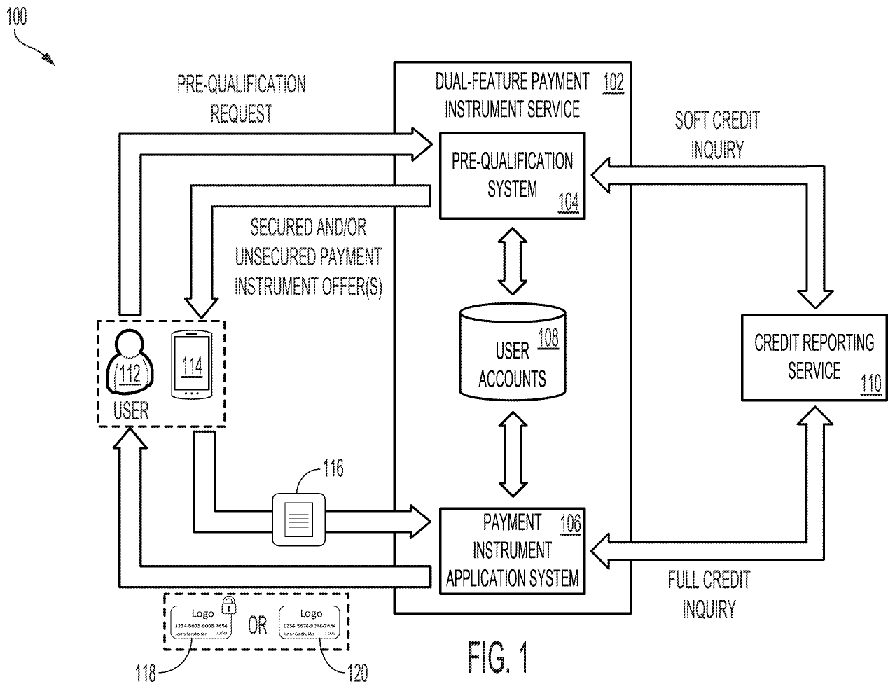

FIG. 1 shows an illustrative example of an environment 100 in which secured and unsecured payment instrument offers are automatically generated in response to pre-qualification requests and to submission of applications for a new line of credit associated with a secured or unsecured payment instrument in accordance with at least one embodiment. In the environment 100, a user 112, through use of their computing device 114 (e.g., smartphone, tablet computer, desktop computer, etc.), may submit a request to a dual-feature payment instrument service 102 to determine whether the user 112 is pre-qualified for one or more payment instruments. In an embodiment, the user 112 is associated with an account provided by the dual-feature payment instrument service 102 or other entity associated with the dual-feature payment instrument service 102 (e.g., a third-party payment instrument service, a merchant, etc.). For instance, the user 112 may have an existing account associated with the dual-feature payment instrument service 102 whereby the user 112 may have one or more existing lines of credit associated with secured and/or unsecured payment instruments.

In some instances, the user 112 may not have a pre-existing relationship with the dual-feature payment instrument service 102. For instance, the user 112 may be a new customer that is interested in establishing a new line of credit through the dual-feature payment instrument service 102. As an illustrative example, the user 112 may be presented with advertisements related to the dual-feature payment instrument service 102, whereby the user 112 may be presented with different payment instrument options that may generally be available from the dual-feature payment instrument service 102. These advertisements may be presented in the form of billboards, radio media, television or digital video media, banner advertisements, pop-up advertisements, and the like. In response to these advertisements, the user 112 may access the dual-feature payment instrument service 102 to submit a request to determine whether the user 112 is pre-qualified for one or more payment instruments offered by the dual-feature payment instrument service 102.

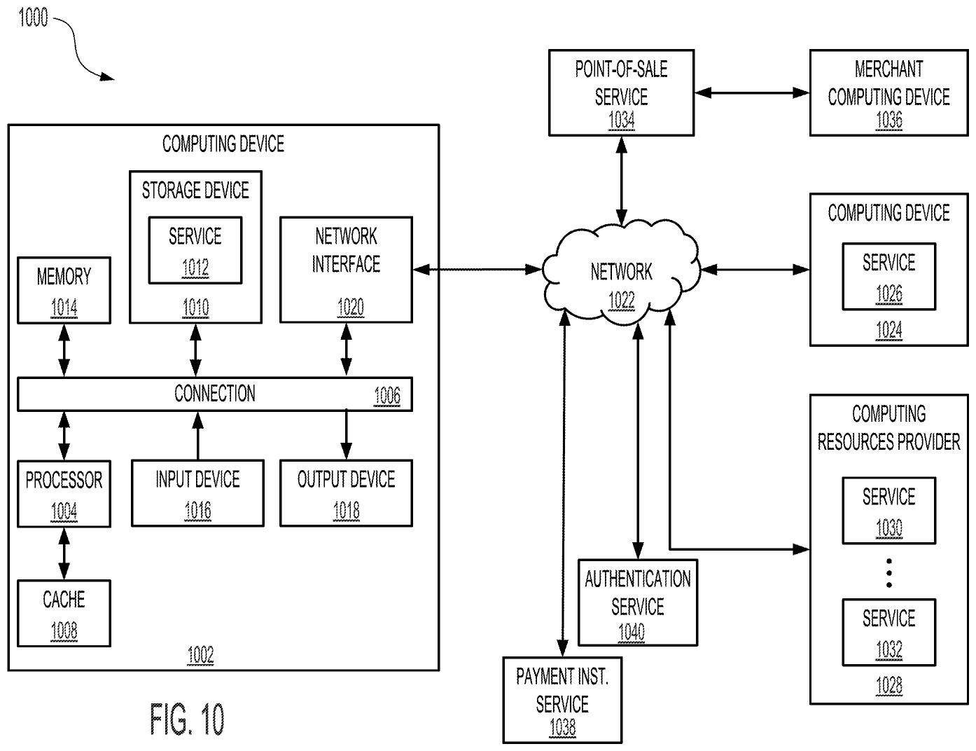

The dual-feature payment instrument service 102, in an embodiment, is a service that, for example, processes applications for secured dual-feature payment instruments, issues secured dual-feature payment instruments, receives deposits used to secure the secured dual-feature payment instruments, processes transactions associated with secured dual-feature payment instruments, determines whether a secured dual-feature payment instrument should be graduated to an unsecured dual-feature payment instrument, processes the graduation of the secured dual-feature payment instrument to an unsecured dual-feature payment instrument, issues unsecured dual-feature payment instruments, processes transactions associated with unsecured dual-feature payment instruments, processes cancellations of accounts associated with secured and unsecured dual-feature payment instruments, and performs other such operations. In an embodiment, the dual-feature payment instrument service 102 is a service such as the service 1012 described herein at least in connection with FIG. 10. In an embodiment, the dual-feature payment instrument service 102 is a service provided by a merchant such as the merchants described herein at least in connection with FIG. 10. In an embodiment, the dual-feature payment instrument service 102 is a service provided by a computing resources provider such as the computing resource provide 1028 described herein at least in connection with FIG. 10 (e.g., a service such as service 1030 and/or service 1032 described herein at least in connection with FIG. 10). In an embodiment, the dual-feature payment instrument service 102 is a payment instrument service such as the payment instrument service 1038 described herein at least in connection with FIG. 10. In some instances, the dual-feature payment instrument service 102 may be a service operated by the issuer of the secured dual-feature payment instrument and/or the unsecured dual-feature payment instrument. In some instances, the dual-feature payment instrument service 102 may be a service operated by a third-party on behalf of the issuer of the secured dual-feature payment instrument and/or the unsecured dual-feature payment instrument.

In an embodiment, the pre-qualification request from the user 112 includes information that can be used to perform a soft inquiry of the user's credit report in order to determine whether the user is pre-qualified for one or more lines of credit associated with different payment instruments offered by the dual-feature payment instrument service 102, such as secured and unsecured payment instruments. For instance, through the pre-qualification request, the user 112 may provide their legal name, birthdate, last four digits of their Social Security number, household income, and the like. If the user 112 has an existing account associated with the dual-feature payment instrument service 102, the user 112 may provide a set of credentials associated with the existing account (e.g., username, password, cryptographic token(s), etc.) that may be validated by the pre-qualification system 104 and used to access the existing account from a user accounts datastore 108. Through the existing account, the pre-qualification system 104 may automatically obtain the requisite information for conducting the soft inquiry of the user's credit report, as described in greater detail herein.

In some instances, the pre-qualification request may specify one or more preferences for specific secured and/or unsecured payment instruments that the user 112 may be interested in. For example, through a pre-qualification system 104 of the dual-feature payment instrument service 102, the user 112 may be presented with a listing or other catalog of the available payment instruments that the dual-feature payment instrument service 102 provides. Each option provided in the listing or other catalog of the available payment instruments may indicate any benefits associated with the corresponding payment instrument (e.g., cash back percentages or amounts, loyalty rewards, discounts, free credit monitoring, etc.). This may allow the user 112 to select any preferences related to payment instruments that the user 112 may be interested in.

The pre-qualification system 104 may be implemented using a computer system of the dual-feature payment instrument service 102. In some instances, the pre-qualification system 104 may be implemented as an application or executable process that is executed on a computer system of the dual-feature payment instrument service 102. In an embodiment, if the user 112 has provided a set of credentials corresponding to an existing account associated with the dual-feature payment instrument service 102, the pre-qualification system 104 may authenticate the provided set of credentials to ensure that the set of credentials correspond to the existing account and that the user 112 is authorized to access this existing account. If the set of credentials are successfully authenticated, the pre-qualification system 104 may access the user accounts datastore 108 to retrieve the information required for the soft inquiry of the user's credit report from the user's existing account. If the user 112 does not have an existing account associated with the dual-feature payment instrument service 102, the pre-qualification system 104 may forego this process of accessing the user accounts datastore 108 to retrieve the required information from an existing account.

In an embodiment, the pre-qualification system 104 automatically submits a soft credit inquiry to a credit reporting service 110 to obtain a preliminary credit evaluation for the user 112. For instance, the result of soft credit inquiry may include one or more credit scores associated with the user 112, the current amount of credit allocated to the user 112 from different financial entities (including the dual-feature payment instrument service 102, if any), the current amount of credit available to the user 112, and the like. Since the pre-qualification system 104 is performing a soft credit inquiry for the user 112, there is no impact to the user's credit scores unless the user 112 opts to submit a complete application for a particular payment instrument offered by the dual-feature payment instrument service 102. The credit reporting service 110 may be associated with one or more credit agencies (e.g., Equifax®, TransUnion®, Experian®, etc.) or may otherwise interact with one or more credit agencies to provide credit reporting to users and other entities (such as the pre-qualification system 104).

In an embodiment, the pre-qualification system 104 implements and dynamically trains, in real-time, a machine learning algorithm or artificial intelligence to identify one or more payment instruments that may be offered to the user 112 based on the result of the soft credit inquiry, the user's preferences (if any), and historical data corresponding to the user and other users associated with the dual-feature payment instrument service 102. For example, the pre-qualification system 104 may implement and dynamically train, in real-time, a clustering algorithm to identify similar accounts and/or account holders based on one or more vectors of similarity between parameters associated with the user being evaluated (e.g., results of the soft credit inquiry, known preferences, historical data, etc.) and other clusters corresponding to different payment instrument determinations corresponding to different payment instruments made available by the dual-feature payment instrument service 102 and to approval decisions. These vectors of similarity may include, but are not limited to, credit scores, changes in credit scores, spending habits, total amount of credit allocated, total amount of credit available, payment performance, demographic information, and the like. These similar accounts and/or account holders may correspond to different payment instruments issued to these account holders based on the one or more vectors of similarity. In some instances, a dataset of characteristics of accounts and users may be analyzed using a clustering algorithm to determine which payment instruments should be recommended to the user 112. The dataset of characteristics of accounts and users may, in an embodiment, include historical data corresponding to the payment instruments these users were pre-qualified for, the payment instruments recommended to these users, and the users' feedback corresponding to these recommendations (e.g., user selections from a listing of recommended payment instruments, user rejections of recommended payment instruments, etc.).

Example clustering algorithms may be trained using the collected dataset. In an embodiment, clustering algorithms are dynamically trained in real-time using sample datasets of characteristics of accounts, users, and/or secured and unsecured dual-feature payment instruments to classify accounts, customers, and/or secured and unsecured dual-feature payment instruments in order to identify secured and unsecured dual-feature payment instruments that may be recommended to users based on the results of their soft credit inquiries. Examples of such clustering algorithms may include, but are not limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

It should be noted that the machine learning algorithm or artificial intelligence implemented by the pre-qualification system 104 may be dynamically trained, in real-time, to continuously, and automatically, process soft credit inquiries, the user preferences (if any), and historical data corresponding to different users associated with the dual-feature payment instrument service 102 as these different users submit pre-qualification requests to the pre-qualification system 104. This continuous processing of pre-qualification requests and corresponding user parameters (e.g., results of soft credit inquiries, preferences, historical data, etc.) may be performed independently and in parallel for myriad users and corresponding pre-qualification requests in real-time as these pre-qualification requests are received. Further, the machine learning algorithm or artificial intelligence may be continuously updated, in real-time, as payment instrument recommendations are provided and as users respond to these payment instrument recommendations (e.g., user selections from a listing of recommended payment instruments, user rejections of recommended payment instruments, etc.). These user responses may be used as feedback corresponding to the recommendations generated by the machine learning algorithm or artificial intelligence. Thus, based on these responses, the machine learning algorithm or artificial intelligence may be continuously, and dynamically, updated in real-time to improve or reinforce the accuracy of the machine learning algorithm or artificial intelligence in generating payment instrument recommendations for different users based on their corresponding user parameters.

Based on the output of the machine learning algorithm or artificial intelligence built from existing user accounts, corresponding soft credit inquiry results, and secured/unsecured dual-feature payment instruments offered by the dual-feature payment instrument service 102, a determination as to what secured and unsecured dual-feature payment instruments may be offered to the user 112 may be made by the pre-qualification system 104. For instance, the pre-qualification system 104 may provide, to the user 112, a listing of secured and/or unsecured dual-feature payment instruments that the user 112 may be pre-qualified for, as well as details corresponding to the benefits of these payment instruments and any financial terms that may be associated with these payment instruments. For example, if the user 112 is pre-qualified for a secured dual-feature payment instrument, the pre-qualification system 104 may provide the user 112 with an indication corresponding to an amount required as a security deposit for the secured dual-feature payment instrument, as well as a range corresponding to the interest rates that may be associated with the secured dual-feature payment instrument based on the user's credit worthiness and/or other factors (e.g., household income, payment performance, etc.). Additionally, the pre-qualification system 104 may indicate any ancillary benefits associated with the secured dual-feature payment instrument, such as an amount of cash back for purchases, loyalty rewards points for purchases, discounts, free credit monitoring, and the like. Similarly, if the user 112 is pre-qualified for an unsecured dual-feature payment instrument, the pre-qualification system 104 may provide the user 112 with a range corresponding to the interest rates that may be associated with the unsecured dual-feature payment instrument based on the user's credit worthiness and/or other factors (e.g., household income, payment performance, etc.), as well as any ancillary benefits associated with the unsecured dual-feature payment instrument.

Information corresponding to the recommended secured and/or unsecured dual-feature payment instruments that the user 112 is pre-qualified for may be presented concurrently to the user 112 via an interface, such as a graphical user interface (GUI). For instance, through the interface, the user 112 may review and compare the information corresponding to these recommended secured and/or unsecured dual-feature payment instruments in order to determine whether to submit a complete application for a particular secured or unsecured dual-feature payment instrument. In some examples, the pre-qualification system 104 may further provide, through the interface, information corresponding to other secured and/or unsecured dual-feature payment instruments that the user 112 may be pre-qualified for but that are not recommended by the pre-qualification system 104. The information corresponding to these other secured and/or unsecured dual-feature payment instruments may be less prominently presented through the interface compared to the information corresponding to the recommended secured and/or unsecured dual-feature payment instruments that the user 112 may be pre-qualified for.

In an embodiment, if the user 112 opts to apply for one or more secured and/or unsecured dual-feature payment instruments, or decides to reject the recommendations provided by the pre-qualification system 104, the pre-qualification system 104 can incorporate this feedback into the dataset used to train the machine learning algorithm or artificial intelligence used to identify secured and unsecured dual-feature payment instruments that may be recommended to users. For instance, if the user 112 opts to apply for a particular secured or unsecured dual-feature payment instrument recommended by the pre-qualification system 104, the pre-qualification system 104 may use this response from the user 112 as a positive indication that the user 112 has accepted the recommendations provided by the machine learning algorithm or artificial intelligence. This positive indication may be used to reinforce the machine learning algorithm or artificial intelligence such that similar recommendations may be provided to similarly-situated users (e.g., users have similar credit scores, changes in credit scores, spending habits, total amount of credit allocated, total amount of credit available, payment performance, demographic information, etc.). Alternatively, if the user 112 rejects the recommended secured and/or unsecured dual-feature payment instruments (e.g., the user 112 applies for an alternative secured or unsecured dual-feature payment instrument than those recommended, the user 112 foregoes applying for any dual-feature payment instrument, etc.), the pre-qualification system 104 may use this response from the user 112 as a negative indication that the user 112 has not accepted the recommendation put forward by the pre-qualification system 104. This negative indication may be used to retrain the machine learning algorithm or artificial intelligence such that, for similar users, the likelihood of similar dual-feature payment instruments being recommended is reduced.

In an embodiment, the machine learning algorithm or artificial intelligence implemented by the pre-qualification system 104 is configured to simultaneously process, in real-time, multiple pre-qualification requests and corresponding soft credit inquiry results for various users in order to provide tailored recommendations for different secured and unsecured dual-feature payment instruments to these various users. This may allow the pre-qualification system 104 to process numerous pre-qualification requests at the same time without creating a backlog that may hinder the user experience. Further, the pre-qualification system 104 can dynamically, and in real-time, update the dataset used to train the machine learning algorithm or artificial intelligence as users opt to apply for recommended secured and unsecured dual-feature payment instruments or otherwise reject the recommendations provided by the pre-qualification system 104. This may allow for the continuous and dynamic updating of the machine learning algorithm or artificial intelligence in real-time, thereby improving the accuracy of the machine learning algorithm or artificial intelligence in providing appropriate recommendations to users.

It should be noted that while machine learning algorithms and artificial intelligence are described extensively throughout the present disclosure for the purpose of illustration, other classical algorithms or systems that do not require training may be implemented to simultaneously process, in real-time, multiple pre-qualification requests to identify the secured and/or unsecured dual-feature payment instruments that users may be pre-qualified for. For instance, the pre-qualification system 104 may implement an algorithm or other executable code that may continuously process incoming pre-qualification requests and corresponding soft credit inquiry results according to one or more formulae to determine which secured and unsecured dual-feature payment instruments users may be pre-qualified for. This algorithm or other executable code may be manually updated as determinations are made using the algorithm or other executable code and as user performance with regard to maintenance of their payment instruments is obtained (e.g., changes to credit scores, changes to payment histories, any defaults, etc.).

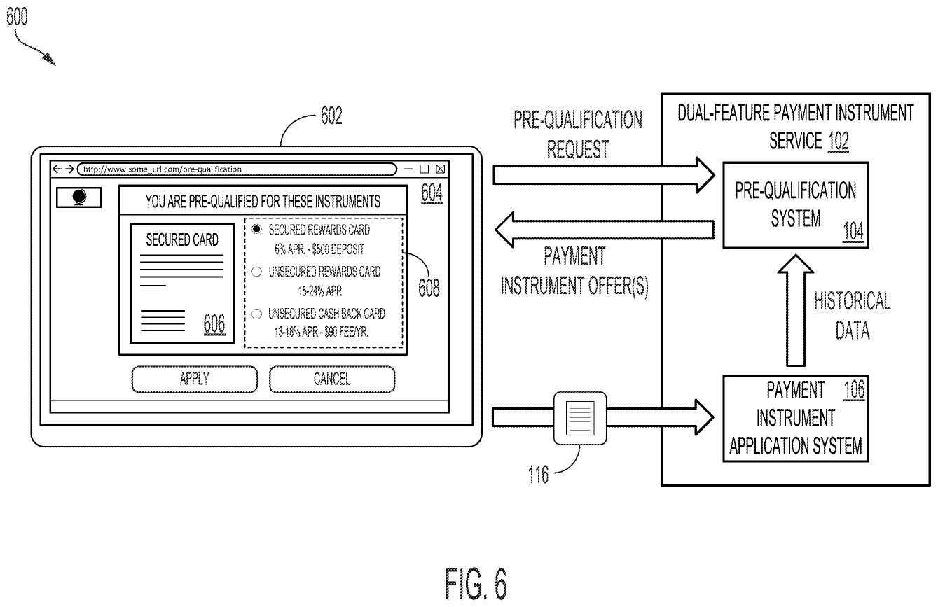

As noted above, the user 112 may opt to apply for one or more secured and/or unsecured dual-feature payment instruments recommended by the pre-qualification system 104 or that the user 112 is otherwise pre-qualified for. Accordingly, as illustrated in FIG. 1, the user 112 may transmit an application 116 to a payment instrument application system 106 of the dual-feature payment instrument service 102 to formally apply for a particular secured or unsecured dual-feature payment instrument. The payment instrument application system 106 may be implemented using a computer system of the dual-feature payment instrument service 102. In some instances, the payment instrument application system 106 may be implemented as an application or executable process that is executed on a computer system of the dual-feature payment instrument service 102. The application 116 may provide the user's authorization to conduct a full credit inquiry to determine whether the user 112 can be approved for the particular secured or unsecured dual-feature payment instrument selected by the user 112. In some instances, the user 112 may access the application 116 through the interface provided by the pre-qualification system 104 to present the user 112 with the recommended secured and/or unsecured dual-feature payment instruments that the user 112 is pre-qualified for. For example, as illustrated in FIG. 6, the user 112 may be provided with options (e.g., options 608 as illustrated in FIG. 6) to select a particular secured or unsecured dual-feature payment instrument that the user 112 would like to apply for.

In response to receiving an application 116 for a particular secured or unsecured dual-feature payment instrument, the payment instrument application system 106 may automatically submit a hard credit inquiry (e.g., a full credit inquiry) to a credit reporting service 110 to obtain a complete credit evaluation for the user 112. The payment instrument application system 106 may obtain, from the credit reporting service 110, the complete credit evaluation for the user 112, which the payment instrument application system 106 may use to determine whether the user 112 can be approved for the particular secured or unsecured dual-feature payment instrument that the user 112 has applied for. If the payment instrument application system 106 determines that the user 112 cannot be approved for the applied for secured or unsecured dual-feature payment instrument, the payment instrument application system 106 may transmit a notification to the user 112 to indicate that the user 112 was not approved for the selected secured or unsecured dual-feature payment instrument. Alternatively, if the payment instrument application system 106 determines, based on the complete credit evaluation for the user 112, that the user 112 is approved for the selected secured or unsecured dual-feature payment instrument, the payment instrument application system 106 may transmit a notification to the user 112 that they have been approved. Additionally, the payment instrument application system 106 may provide any related terms and conditions related to the selected secured or unsecured dual-feature payment instrument that the user 112 has been approved for (e.g., actual annual percentage rate (APR), amount of a line of credit associated with the dual-feature payment instrument, any security deposits required for the dual-feature payment instrument, etc.).

In an embodiment, regardless of whether the user 112 is approved or rejected for the selected secured or unsecured dual-feature payment instrument based on the user's complete credit evaluation, the payment instrument application system 106 can determine whether new offers for other dual-feature payment instruments can be provided to the user 112. For instance, the payment instrument application system 106 may transmit a request to the pre-qualification system 104 to identify, based on the user's complete credit evaluation, as well as historical data corresponding to the user 112 (including the approval decision made by the payment instrument application system 106) and other users associated with the dual-feature payment instrument service 102, any new offers that may be presented to the user 112. If the pre-qualification system 104 identifies any new offers for secured and/or unsecured dual-feature payment instruments that may be presented to the user 112, the pre-qualification system 104 may provide these new offers to the payment instrument application system 106. This may cause the payment instrument application system 106 to present these new offers to the user 112 along with an indication regarding the user 112 either being approved or rejected for the applied for secured or unsecured dual-feature payment instrument.

In some instances, the payment instrument application system 106 may determine whether to promote one or more of these new offers over the secured or unsecured dual-feature payment instrument that the user 112 has been approved for. For instance, the payment instrument application system 106 may implement and dynamically train, in real-time, a machine learning algorithm or artificial intelligence to determine, based on the user's complete credit evaluation and historical data corresponding to the user 112 and other users associated with the dual-feature payment instrument service 102, whether an offer for a different secured or unsecured dual-feature payment instrument would be better suited for the user 112 (e.g., would provide a lesser likelihood of user default or of the user becoming delinquent on payments, would result in a greater improvement in the user's credit score, etc.). The machine learning algorithm or artificial intelligence implemented by the payment instrument application system 106 may include a clustering algorithm that may be used to identify similar account holders and corresponding payment instruments based on one or more vectors of similarity between the user being evaluated and other clusters of payment instrument offers that may be offered. These vectors of similarity may include, but are not limited to, credit scores, changes in credit scores, spending habits, total amount of credit allocated, total amount of credit available, payment performance, demographic information, payment instruments issued, payment instruments in default, and the like. These similar account holders may correspond to the different payment instruments issued to these account holders based on the one or more vectors of similarity, as well as to the performance of these account holders in maintaining their accounts.

In some instances, a dataset of characteristics of accounts and users may be analyzed using a clustering algorithm to determine which payment instruments would be better suited for the user 112. The dataset of characteristics of accounts and users may include historical data corresponding to the payment instruments issued to these users, the users' performance in maintaining the lines of credit associated with these payment instruments in good standing, historical changes to the users' credit scores while maintaining these lines of credit, and the like. Example clustering algorithms may be trained using the collected dataset. Similar to the machine learning algorithm or artificial intelligence implemented by the pre-qualification system 104, the machine learning algorithm or artificial intelligence implemented by the payment instrument application system 106 may be trained using sample datasets of characteristics of accounts, users, and/or secured and unsecured dual-feature payment instruments to classify accounts, customers, and/or secured and unsecured dual-feature payment instruments in order to identify one or more secured and unsecured dual-feature payment instruments that may be recommended to users as alternatives to the approved dual-feature payment instrument based on the results of their complete credit evaluations. Thus, in some embodiments, the payment instrument application system 106, through the machine learning algorithm or artificial intelligence, can perform such clustering and obtain partial matches among other clusters of recommended secured and unsecured dual-feature payment instruments to identify a particular cluster and, from this cluster, identify one or more secured and/or unsecured dual-feature payment instruments that may be recommended to users.

In an embodiment, if the payment instrument application system 106 identifies one or more offers for alternative secured and/or unsecured dual-feature payment instruments that may be better suited for the user 112, the payment instrument application system 106 can provide the user 112 with incentives for selecting an alternative secured or unsecured dual-feature payment instrument. For example, if the output of the machine learning algorithm or artificial intelligence implemented by the payment instrument application system 106 indicates that the user 112 is better suited for an alternative secured or unsecured dual-feature payment instrument, the payment instrument application system 106 may identify one or more incentives that may entice the user 112 in applying for this alternative secured or unsecured dual-feature payment instrument. These incentives may include a reduced APR for a limited time, increased cash back percentages or amounts for a limited time, greater loyalty rewards, greater discounts, and the like.

In an embodiment, the incentives that can be included in an offer for an alternative secured or unsecured dual-feature payment instrument can be identified using the aforementioned machine learning algorithm or artificial intelligence implemented by the payment instrument application system 106. For instance, the machine learning algorithm or artificial intelligence may use available data from the user accounts datastore 108 to determine what incentives the user 112 and other similarly situated users have historically taken advantage of for other dual-feature payment instruments. For example, if the user 112 and/or other similarly situated users have previously used other payment instruments more extensively during promotional periods corresponding to increased cash back percentages or amounts, the payment instrument application system 106 may determine that the user 112 may be more inclined to favor cash back incentives. As another illustrative example, if the user 112 and/or other similarly situated users frequently uses their loyalty rewards for different purposes (e.g., discounts, merchandise, experiences, etc.), the payment instrument application system 106 may determine that the user 112 may be more inclined to accept offers that include additional loyalty rewards benefits. Thus, the machine learning algorithm or artificial intelligence implemented by the payment instrument application system 106 may dynamically identify one or more incentives that may be used to promote a preferred secured or unsecured dual-feature payment instrument that may serve as an alternative to the secured or unsecured dual-feature payment instrument that the user 112 has applied for.

In an embodiment, if the user 112 opts to apply for a different secured or unsecured dual-feature payment instrument offered by the payment instrument application system 106 as an alternative to the secured or unsecured dual-feature payment instrument the user 112 had previously applied for, the payment instrument application system 106 may use the previously performed complete credit evaluation to determine whether the user 112 can be approved for this different secured or unsecured dual-feature payment instrument. If the user 112 is approved for the different secured or unsecured dual-feature payment instrument, the payment instrument application system 106 may provide the user 112 with any related terms and conditions related to the different secured or unsecured dual-feature payment instrument that the user 112 has been approved for. However, if the user 112 is not approved for the different secured or unsecured dual-feature payment instrument, the payment instrument application system 106 may transmit a notification to the user 112 indicating that they have not been approved for the different secured or unsecured dual-feature payment instrument. However, the payment instrument application system 106 may still indicate that the user 112 remains approved for the previously applied for secured or unsecured dual-feature payment instrument. This may allow the user 112 to obtain the secured or unsecured dual-feature payment instrument that the user 112 originally applied for.

Once the user 112 has opted to accept a new line of credit associated with a secured dual-feature payment instrument 118 or an unsecured dual-feature payment instrument 120, the payment instrument application system 106 may issue the secured dual-feature payment instrument 118 or the unsecured dual-feature payment instrument 120 to the user 112. For instance, the payment instrument application system 106 provides physical dual-feature payment instruments to users, the payment instrument application system 106 may mail the secured dual-feature payment instrument 118 or the unsecured dual-feature payment instrument 120 to a mailing address associated with the user 112. Additionally, or alternatively, if the secured dual-feature payment instrument 118 or the unsecured dual-feature payment instrument 120 may be implemented digitally (such as through a digital wallet, etc.), the payment instrument application system 106 may transmit a token representing the secured dual-feature payment instrument 118 or the unsecured dual-feature payment instrument 120 to the user 112. Through a digital wallet or other application on the user's computing device 114, the user 112 may utilize the secured dual-feature payment instrument 118 or the unsecured dual-feature payment instrument 120 for payments.

In an embodiment, the payment instrument application system 106 monitors, in real-time, user accounts associated with the secured and unsecured dual-feature payment instruments issued by the payment instrument application system 106 to users. For instance, as users utilize their secured and unsecured dual-feature payment instruments, the payment instrument application system 106 may record these uses within the user accounts datastore 108 and in association with corresponding user accounts. Further, the payment instrument application system 106 may monitor user repayment or delinquency related to existing secured and unsecured dual-feature payment instruments. The payment instrument application system 106 may additionally track usage of any benefits associated with these secured and unsecured dual-feature payment instruments, such as usage or accumulation of loyalty rewards, usage or accumulation of cash back benefits (e.g., use of cash benefits to pay down an existing balance, etc.), and the like. As user accounts are updated in real-time according to user utilization of their secured and unsecured dual-feature payment instruments, these updated user accounts may be used to dynamically, and in real-time, update the machine learning algorithms or artificial intelligence implemented by the pre-qualification system 104 and the payment instrument application system 106. For instance, if the payment instrument application system 106 detects that a user 112 has defaulted or is otherwise delinquent in maintaining an existing account associated with an unsecured dual-feature payment instrument 120, the payment instrument application system 106 may update the dataset used to train the machine learning algorithm or artificial intelligence implemented by the pre-qualification system 104 to provide a new data point corresponding to the user's default or delinquency associated with the user's unsecured dual-feature payment instrument 120. The pre-qualification system 104 may, in real-time, use the updated dataset (including the new data point) to retrain the machine learning algorithm or artificial intelligence such that, for similar users, the machine learning algorithm or artificial intelligence is less likely to provide these similar users with offers corresponding to similar unsecured dual-feature payment instruments. Additionally, the payment instrument application system 106 may use this new data point to retrain the machine learning algorithm or artificial intelligence implemented by the payment instrument application system 106 to reduce the likelihood of this machine learning algorithm or artificial intelligence identifying offers for similar unsecured dual-feature payment instruments as being better suited for similar users. Thus, the payment instrument application system 106 may dynamically steer these similar users towards other dual-feature payment instruments.

In an embodiment, the machine learning algorithm or artificial intelligence implemented by the payment instrument application system 106 is dynamically trained and configured to simultaneously process, in real-time, multiple application approval requests, full credit inquiry results, and available offers for alternative payment instruments for various users in order to provide tailored recommendations for different secured and unsecured dual-feature payment instruments that may be better suited for these various users. This may allow the payment instrument application system 106 to process numerous applications for different lines of credit at the same time without creating a backlog that may hinder the user experience. Further, the payment instrument application system 106 can dynamically, and in real-time, update the dataset used to train the machine learning algorithm or artificial intelligence as users opt to either accept the payment instrument that these users applied for or to apply for alternative secured and unsecured dual-feature payment instruments that have been identified as being better suited for the users. This may allow for the continuous and dynamic updating of the machine learning algorithm or artificial intelligence in real-time, thereby improving the accuracy of the machine learning algorithm or artificial intelligence in identifying offers for alternative payment instruments that may be better suited for these users.

It should be noted that while machine learning algorithms and artificial intelligence are described extensively throughout the present disclosure for the purpose of illustration, other classical algorithms or systems that do not require training may be implemented to simultaneously process, in real-time, multiple applications for different lines of credit to determine whether these applications may be approved and to identify any offers for alternative payment instruments that may be better suited for the users submitting these applications. For instance, payment instrument application system 106 may implement an algorithm or other executable code that may continuously process incoming applications, corresponding full credit inquiry results, and offers for other payment instruments that corresponding users may be pre-qualified for according to one or more formulae to determine whether these users can be approved for applied for lines of credit and to identify any offers for other payment instruments that may be better suited for these users. This algorithm or other executable code may be updated as determinations are made using the algorithm or other executable code and as user performance with regard to maintenance of their payment instruments is obtained (e.g., changes to credit scores, changes to payment histories, any defaults, etc.).

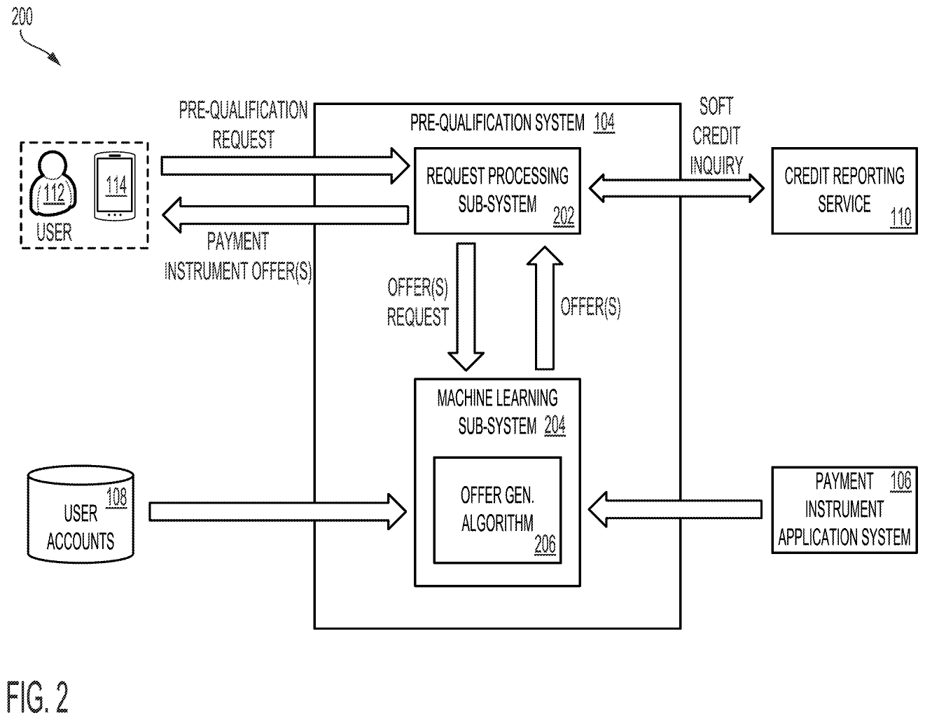

FIG. 2 shows an illustrative example of an environment 200 in which a pre-qualification system 104 of a dual-feature payment instrument service automatically generates one or more payment instrument offers in response to a pre-qualification request in accordance with at least one embodiment. In the environment 200, a user 112, through a computing device 114, may submit a pre-qualification request to a request processing sub-system 202 of the pre-qualification system 104. The request processing sub-system 202 may be implemented using a computer system of the pre-qualification system 104. In some instances, the request processing sub-system 202 may be implemented as an application or executable process that is executed on a computer system of the pre-qualification system 104. As noted above, a pre-qualification request may include information that can be used to perform a soft inquiry of the user's credit report in order to determine whether the user is pre-qualified for one or more lines of credit associated with different payment instruments offered by the dual-feature payment instrument service. Further, the pre-qualification request may specify one or more preferences for specific secured and/or unsecured payment instruments that the user 112 may be interested in. This may reduce the pool of secured and/or unsecured payment instruments offered by the dual-feature payment instrument service from which the pre-qualification system 104 may generate offers for the user 112.

In response to the pre-qualification request, the request processing sub-system 202 may submit a request to a credit reporting service 110 to perform a soft credit inquiry of the user's credit report. The credit reporting service 110, in response to the soft credit inquiry, may provide the request processing sub-system 202 with data that may be used to determine the user's credit performance over time. This data, for instance, may include one or more credit scores associated with the user 112, the current amount of credit allocated to the user 112 from different financial entities (including the dual-feature payment instrument service, if any), the current amount of credit available to the user 112, the user's credit repayment history, any known delinquencies, and the like.

In an embodiment, the request processing sub-system 202 transmits a request to a machine learning sub-system 204 of the pre-qualification system 104 to obtain one or more offers that may be presented to the user 112. These one or more offers may correspond to secured and/or unsecured dual-feature payment instruments that the user 112 may be pre-qualified for based on the data obtained by the request processing sub-system 202 in response to the soft credit inquiry to the credit reporting service 110. Thus, the request may include the data obtained by the request processing sub-system 202 from the credit reporting service 110 and corresponding to the user's credit performance over time. The machine learning sub-system 204 may be implemented using a computer system of the pre-qualification system 104. In some instances, the machine learning sub-system 204 may be implemented as an application or executable process that is executed on a computer system of the pre-qualification system 104.

The machine learning sub-system 204, in an embodiment, implements an offer generation algorithm 206 that is configured to automatically, and dynamically, identify one or more secured and/or unsecured dual-feature payment instruments that a user (e.g., user 112 or other user) is pre-qualified for. Further, the offer generation algorithm 206 may be configured to automatically, and dynamically generate one or more offers corresponding to the identified one or more secured and/or unsecured dual-feature payment instruments that a particular user is pre-qualified for. The offer generation algorithm 206, in an embodiment, is a machine learning algorithm or artificial intelligence that is dynamically trained to identify the one or more secured and/or unsecured dual-feature payment instruments that a user is pre-qualified for and to generate offers corresponding to these secured and/or unsecured dual-feature payment instruments. For instance, the offer generation algorithm 206 may be implemented using a clustering algorithm that is trained to identify similar accounts and/or account holders (e.g., users) based on one or more vectors of similarity (e.g., credit scores, changes in credit scores, spending habits, total amount of credit allocated, total amount of credit available, payment performance, demographic information, etc.). These similar accounts and/or account holders may correspond to different payment instruments issued to these account holders based on the one or more vectors. In some instances, a dataset of characteristics of accounts and users may be analyzed using a clustering algorithm to determine which payment instruments should be recommended to the user 112. The dataset of characteristics of accounts and users may, in an embodiment, include historical data corresponding to the payment instruments these users were pre-qualified for, the payment instruments recommended to these users, and the users' feedback corresponding to these recommendations (e.g., user selections from a listing of recommended payment instruments, user rejections of recommended payment instruments, etc.). Thus, the offer generation algorithm 206 may be trained using sample datasets of characteristics of accounts, users, and/or secured and unsecured dual-feature payment instruments to classify accounts, customers, and/or secured and unsecured dual-feature payment instruments in order to identify secured and unsecured dual-feature payment instruments that may be recommended to users based on the results of their soft credit inquiries. These sample datasets may be generated based on information stored in the user accounts datastore 108.

In an embodiment, the machine learning sub-system 204 uses the result of the soft credit inquiry, the user's preferences (if any), and historical data corresponding to the user and other users associated with the dual-feature payment instrument service as input to the offer generation algorithm 206 to identify one or more secured and/or unsecured dual-feature payment instruments that the user 112 is pre-qualified for and to generate one or more recommended offers to apply for one or more secured and/or unsecured dual-feature payment instruments that the user 112 is pre-qualified for. For instance, the offer generation algorithm 206 may use the result of the soft credit inquiry associated with the user 112 and automatically identify a cluster of similarly situated users according to one or more vectors of similarity corresponding to features of the soft credit inquiry result (e.g., credit scores, changes in credit scores, spending habits, total amount of credit allocated, total amount of credit available, payment performance, demographic information, etc.). From this cluster of similarly situated users, the offer generation algorithm 206 can identify a dataset that indicates which payment instruments have historically been offered to these similarly situated users, which payment instruments these similarly situated users have applied for, which payment instruments were actually issued to these similarly situated users, these users' management of the payment instruments issued to these users (e.g., repayment history, delinquency history, default history, etc.), and any changes to these users' credit resulting from their management of the payment instruments issued to these users (e.g., changes to credit scores over time, etc.). Based on this dataset, the offer generation algorithm 206 may identify which secured and/or unsecured dual-feature payment instruments the user 112 is pre-qualified for and, based on this identification and the aforementioned dataset, select one or more secured and/or unsecured dual-feature payment instruments that may be recommended to the user 112.

The machine learning sub-system 204, in response to obtaining a recommendation from the offer generation algorithm 206 and that corresponds to one or more secured and/or unsecured dual-feature payment instruments that the user 112 is pre-qualified for, may provide this recommendation to the request processing sub-system 202 to fulfill the request from the request processing sub-system 202 to obtain a set of offers that may be presented to the user 112. The request processing sub-system 202 may provide, to the user 112 and based on the recommendation generated by the offer generation algorithm 206, a listing of secured and/or unsecured dual-feature payment instruments that the user 112 may be pre-qualified for and that are recommended for the user 112 based on their credit history and preferences. The listing of secured and/or unsecured dual-feature payment instruments may further include details corresponding to the benefits of these payment instruments and any financial terms that may be associated with these payment instruments. Information corresponding to the recommended secured and/or unsecured dual-feature payment instruments that the user 112 is pre-qualified for may be presented concurrently to the user 112 via an interface, such as a GUI as described above. Through the interface, the user 112 may review and compare the information corresponding to the secured and/or unsecured dual-feature payment instruments recommended by the offer generation algorithm 206 in order to determine whether to submit a complete application for a particular secured or unsecured dual-feature payment instrument.

In some instances, the request processing sub-system 202 may further provide, through the interface, information corresponding to other secured and/or unsecured dual-feature payment instruments that the user 112 may be pre-qualified for but that were not recommended by the offer generation algorithm 206. This may provide the user 112 with additional options to apply for other secured or unsecured dual-feature payment instruments that the user 112 may favor over those recommended by the offer generation algorithm 206. Further, as described in greater detail herein, this may provide another vector of feedback that may be used to update the offer generation algorithm 206. For instance, if the user 112 opts to apply for a secured or unsecured dual-feature payment instrument that was not recommended by the offer generation algorithm 206, this action may be used as feedback indicative of the user's rejection of the recommendations provided by the offer generation algorithm 206 and of the actual user preferences with regard to the secured or unsecured dual-feature payment instrument that is of interest to the user 112. The information corresponding to these other secured and/or unsecured dual-feature payment instruments may be less prominently presented through the interface compared to the information corresponding to the recommended secured and/or unsecured dual-feature payment instruments that the user 112 may be pre-qualified for.

As noted above, if the user 112 opts to apply for one or more secured and/or unsecured dual-feature payment instruments recommended by the offer generation algorithm 206, or decides to reject the recommendations provided by the offer generation algorithm 206 (e.g., the user 112 opts to apply for a payment instrument not recommended by the offer generation algorithm 206, the user 112 opts not to apply for any payment instrument, etc.), the machine learning sub-system 204 may incorporate this feedback into the dataset used to train the offer generation algorithm 206. For instance, if the user 112 opts to apply for a particular secured or unsecured dual-feature payment instrument recommended by the offer generation algorithm 206, the machine learning sub-system 204 may use this positive feedback to reinforce the offer generation algorithm 206 such that similar recommendations may be provided to similarly situated users. Alternatively, if the user 112 rejects the recommended secured and/or unsecured dual-feature payment instruments, the machine learning sub-system 204 may use this negative feedback that may be used to retrain the offer generation algorithm 206 such that, for similar users, the likelihood of similar dual-feature payment instruments being recommended is reduced.

In an embodiment, the offer generation algorithm 206 can be further updated based on data from the payment instrument application system 106. As noted above, the payment instrument application system 106 may process applications for different secured and unsecured dual-feature payment instruments to determine whether users may be approved for new lines of credit associated with these different payment instruments. For instance, the payment instrument application system 106 may determine, based on a complete credit evaluation of an applicant (e.g., user), whether the applicant can be approved for a new line of credit associated with the selected payment instrument. The approval determinations made by the payment instrument application system 106 may be used to update the dataset utilized by the machine learning sub-system 204 to train the offer generation algorithm 206. For example, if the offer generation algorithm 206 previously recommended a particular payment instrument to a user, and the user is subsequently rejected by the payment instrument application system 106 as a result of the complete credit evaluation of the user, the offer generation algorithm 206 may be updated such that, for similarly-situated users (e.g., users having a similar credit profile, etc.), the likelihood of a similar payment instrument being recommended is reduced. Alternatively, if the offer generation algorithm 206 previously recommended a particular payment instrument to a user, and the user is subsequently approved by the payment instrument application system 106, the offer generation algorithm 206 may be updated such that, for similarly-situated users, the likelihood of a similar payment instrument being recommended is maintained or increased (e.g., the offer generation algorithm 206 is reinforced).

In an embodiment, the offer generation algorithm 206 can further be updated based on the ongoing and real-time performance of users (such as user 112) with regard to their dual-feature payment instruments. For example, as users utilize their dual-feature payment instruments for different transactions, make payments towards existing balances associated with these dual-feature payment instruments, or as changes are otherwise made to these users' credit histories (e.g., real-time updates to credit scores, detection of defaults or delinquencies, detection of new lines of credit established through the dual-feature payment instrument service or other financial institution, etc.), the machine learning sub-system 204 can, in real-time, update the offer generation algorithm 206 accordingly. For example, if the machine learning sub-system 204 detects that a user has defaulted on an existing line of credit associated with a particular secured or unsecured dual-feature payment instrument, the machine learning sub-system 204 may dynamically, and in real-time, update the offer generation algorithm 206 such that the likelihood of similarly-situated users being recommended similar payment instruments is reduced. Alternatively, if the machine learning sub-system 204 detects an increase in a user's credit score resulting from the user's responsible maintenance of the line of credit associated with a particular dual-feature payment instrument, the machine learning sub-system 204 may dynamically, and in real-time, update the offer generation algorithm 206 such that the likelihood of similar dual-feature payment instruments being recommended to similarly-situated users is either maintained or increased. These dynamic, and real-time updates to the dataset used to train the offer generation algorithm 206 may allow for the continuous and dynamic updating of the offer generation algorithm 206 in real-time, thereby improving the accuracy of the offer generation algorithm 206 in providing appropriate recommendations to users.

The offer generation algorithm 206, in an embodiment, is implemented and configured to simultaneously process, in real-time, multiple requests from the request processing sub-system 202 for tailored recommendations that can be provided to different users for different payment instruments. Similarly, the request processing sub-system 202 is configured to process any number of pre-qualification requests simultaneously or as they are received from users. This may allow the request processing sub-system 202 and the offer generation algorithm 206 to process numerous pre-qualification requests and provide recommendations at the same time without creating a backlog that may hinder the user experience.

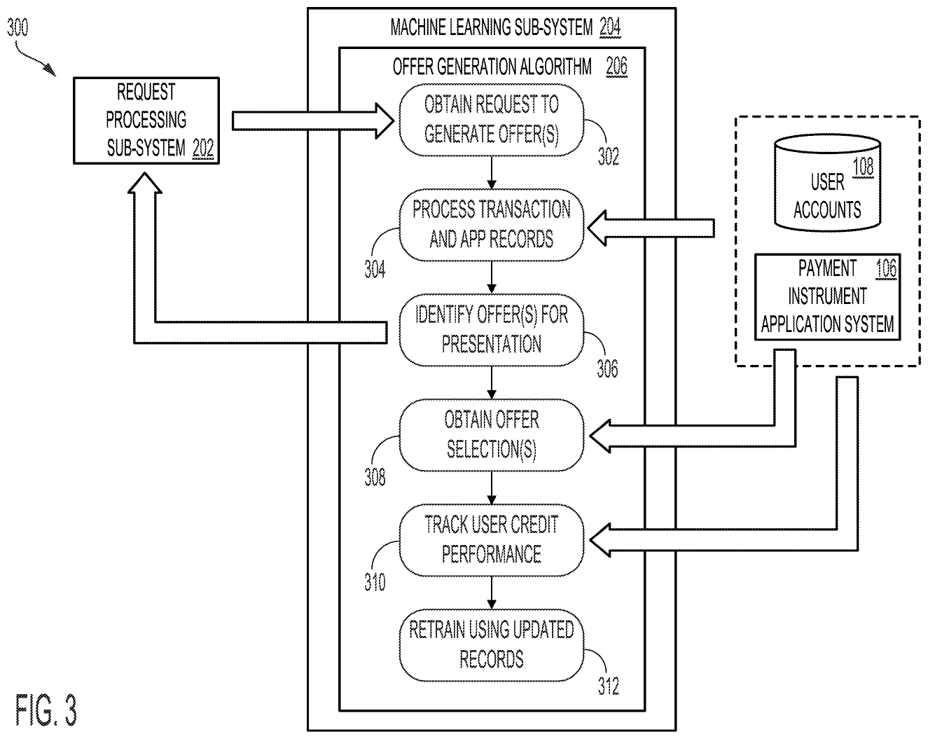

FIG. 3 shows an illustrative example of an environment 300 in which an offer generation algorithm 206 processes results from a soft credit inquiry, transaction records, and data from previous applications for lines of credit associated with user accounts to identify and generate one or more payment instrument offers in accordance with at least one embodiment. As noted above, a request processing sub-system 202 of the pre-qualification system may transmit a request to the machine learning sub-system 204 to generate one or more payment instrument offers that may be recommended to a particular user. The machine learning sub-system 204 may implement an offer generation algorithm 206 that is dynamically trained to identify any secured and/or unsecured dual-feature payment instruments that a user is pre-qualified for and to generate, based on this identification, one or more payment instrument offers that may be recommended to the user.

At step 302, the offer generation algorithm 206 may obtain a request to generate one or more offers to apply for one or more payment instruments that a user may be pre-qualified for and that may be recommended to a particular user. The request transmitted by the request processing sub-system 202 to the machine learning sub-system 204 may include the data obtained by the request processing sub-system 202 from a credit reporting service and corresponding to the user's credit performance over time, as noted above. Further, the request may indicate any preferences specified by the user for specific secured and/or unsecured dual-feature payment instruments that the user may be interested in.

At step 304, the offer generation algorithm 206 may process transaction and application records associated with the user (if any) and of other users associated with the dual-feature payment instrument service. These transaction and application records may be obtained by the offer generation algorithm 206 from the user accounts datastore 108 and from the payment instrument application system 106. For example, the user accounts datastore 108 may store historical transaction and application records for various users (past and present) to whom secured and unsecured dual-feature payment instruments have been issued. Further, the historical transaction and application records may include information corresponding to credit scores, changes in credit scores, spending habits, total amounts of credit allocated, total amounts of credit available, payment performance, and the like for each of these users. In some instances, the offer generation algorithm 206 can obtain, in real-time, application records generated by the payment instrument application system 106 as the payment instrument application system 106 processes new applications for lines of credit associated with different secured and unsecured dual-feature payment instruments. These application records may similarly include the aforementioned information, as well as approval determinations (e.g., approve or deny) generated by the payment instrument application system 106.

At step 306, the offer generation algorithm 206 may identify one or more offers corresponding to payment instruments that are recommended for the user and that the request processing sub-system 202 may present to the user. As noted above, the offer generation algorithm 206 may use the data corresponding to a present user for whom offers are being generated to identify similar accounts and/or account holders (e.g., users) based on one or more vectors of similarity (e.g., credit scores, changes in credit scores, spending habits, total amount of credit allocated, total amount of credit available, payment performance, demographic information, etc.). These similar accounts and/or account holders may correspond to different payment instruments issued to these account holders based on the one or more vectors of similarity. In some instances, a dataset of characteristics of accounts and users may be analyzed by the offer generation algorithm 206 to determine which payment instruments should be recommended and offered to the user. The dataset of characteristics of accounts and users may include historical data corresponding to the payment instruments these users were pre-qualified for, the payment instruments recommended to these users, and the users' feedback corresponding to these recommendations (e.g., user selections from a listing of recommended payment instruments, user rejections of recommended payment instruments, etc.).

As noted above, the offer generation algorithm 206 may use the result of the soft credit inquiry associated with the user to automatically identify a cluster of similarly situated users according to one or more vectors of similarity corresponding to features of the soft credit inquiry result (e.g., credit scores, changes in credit scores, spending habits, total amount of credit allocated, total amount of credit available, payment performance, demographic information, etc.). From this cluster of similarly situated users, the offer generation algorithm 206 can identify a dataset that indicates which payment instruments have historically been offered to these similarly situated users, which payment instruments these similarly situated users have applied for, which payment instruments were actually issued to these similarly situated users, these users' management of the payment instruments issued to these users (e.g., repayment history, delinquency history, default history, etc.), and any changes to these users' credit resulting from their management of the payment instruments issued to these users (e.g., changes to credit scores over time, etc.). Based on this dataset, the offer generation algorithm 206 may identify which secured and/or unsecured dual-feature payment instruments the user is pre-qualified for and, based on this identification and the aforementioned dataset, select one or more secured and/or unsecured dual-feature payment instruments that may be recommended to the user. The offer generation algorithm 206 may provide the information corresponding selected one or more secured and/or unsecured dual-feature payment instruments (e.g., type of payment instrument, estimated APR, estimated amount of a line of credit associated with the payment instrument, any security deposits required for the payment instrument, any ancillary benefits associated with the payment instrument, etc.) to the request processing sub-system 202 for presentation to the user.

At step 308, the offer generation algorithm 206 may obtain one or more offer selections made by the user through the payment instrument application system 106. For instance, if a user opts to apply for one or more secured and/or unsecured dual-feature payment instruments recommended by the offer generation algorithm 206, or decides to reject the recommendations provided by the offer generation algorithm 206 (e.g., the user opts to apply for a payment instrument not recommended by the offer generation algorithm 206, the user opts not to apply for any payment instrument, etc.), the machine learning sub-system 204 may incorporate this feedback into the dataset used to train the offer generation algorithm 206. This feedback may be obtained automatically from the payment instrument application system 106, which may process, in real-time, applications for new lines of credit corresponding to different payment instruments. The data from the payment instrument application system 106 may include identifying information associated with the user (e.g., user's legal name, user's physical address, etc.), the payment instruments recommended to the user, and the user's actual selection of a payment instrument in their application. Using the identifying information associated with the user, the dataset used to train the offer generation algorithm 206 may be updated to incorporate the user's feedback with regard to the payment instrument offers recommended to the user.

In addition to obtaining feedback corresponding to the user's choice to apply for a line of credit associated with a recommended payment instrument, to apply for a line of credit not associated with a recommended payment instrument, or to forego applying for a line of credit, the offer generation algorithm 206, at step 310, may further track the credit performance of the user and of other users in order to update the dataset used to train the offer generation algorithm 206. For instance, as noted above, the payment instrument application system 106 may determine, based on a complete credit evaluation of an applicant (e.g., user), whether the applicant can be approved for a new line of credit associated with the selected payment instrument. The approval determinations made by the payment instrument application system 106 may be used to update the dataset used to train the offer generation algorithm 206. Additionally, the dataset may be updated based on the ongoing and real-time performance of users with regard to their dual-feature payment instruments. For example, as users utilize their dual-feature payment instruments for different transactions, make payments towards existing balances associated with these dual-feature payment instruments, or as changes are otherwise made to these users' credit histories, dataset may be updated in real-time accordingly. These dynamic, and real-time updates to the dataset used to train the offer generation algorithm 206 may allow for the continuous and dynamic updating of the offer generation algorithm 206 in real-time (e.g., step 312), thereby improving the accuracy of the offer generation algorithm 206 in providing appropriate recommendations to users.

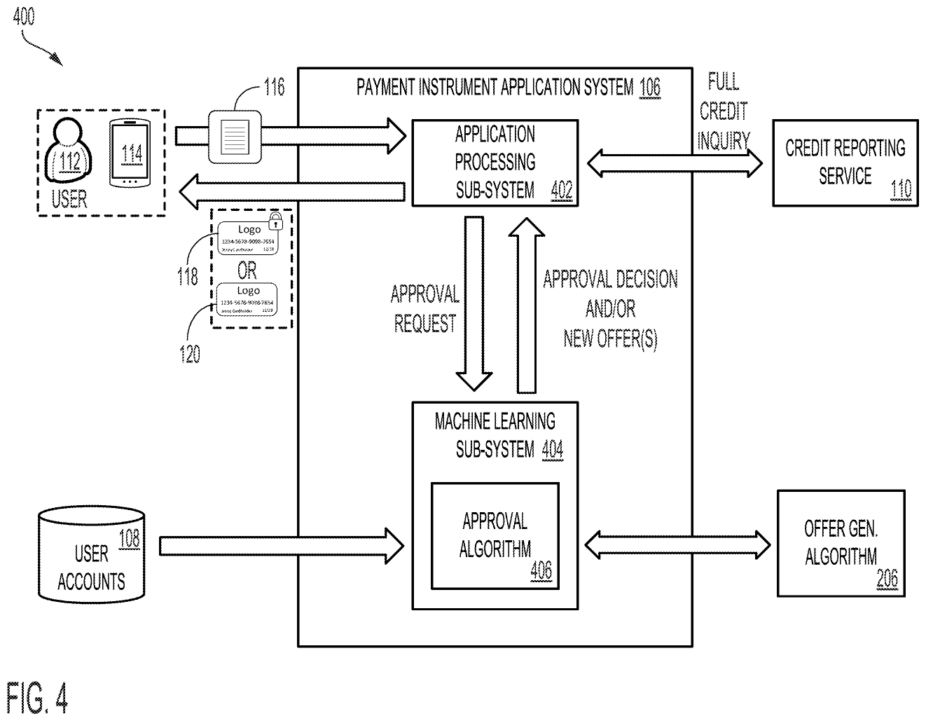

FIG. 4 shows an illustrative example of an environment 400 in which a payment instrument application system 106 of a dual-feature payment instrument service processes an application 116 for a new line of credit and automatically generates new offers for other lines of credit associated with secured and unsecured payment instruments in accordance with at least one embodiment. In the environment 400, a user 112, through a computing device 114, may submit a completed application 116 for a new line of credit associated with a particular secured or unsecured dual-feature payment instrument to an application processing sub-system 402. The application processing sub-system 402 may be implemented using a computer system of the payment instrument application system 106. In some instances, the application processing sub-system 402 may be implemented as an application or executable process that is executed on a computer system of the payment instrument application system 106. As noted above, the user 112 may opt to apply for one or more secured and/or unsecured dual-feature payment instruments recommended by the pre-qualification system or that the user 112 is otherwise pre-qualified for. The application 116 may provide the user's authorization to conduct a full credit inquiry to determine whether the user 112 can be approved for the particular secured or unsecured dual-feature payment instrument selected by the user 112.

In response to receiving the completed application 116 for a new line of credit associated with a particular secured or unsecured dual-feature payment instrument, the application processing sub-system 402 may automatically submit a full credit inquiry to the credit reporting service 110. The full credit inquiry may result in a complete credit evaluation for the user 112. Similar to the soft credit inquiry described above, the result of the full credit inquiry may include, for the user 112, credit scores, changes in credit scores, spending habits, total amount of credit allocated, total amount of credit available, payment performance, demographic information, payment instruments issued, payment instruments in default, and the like. Once the application processing sub-system 402 has obtained the result of the full credit inquiry from the credit reporting service 110, the application processing sub-system 402 may transmit a request to a machine learning sub-system 404 of the payment instrument application system 106 to obtain a decision regarding the application 116 submitted by the user 112 and to identify any offers for other payment instruments that the user 112 may be pre-qualified for. The request may include the application 116 and the result of the full credit inquiry provided by the credit reporting service 110.

The machine learning sub-system 404 may be implemented using a computer system of the payment instrument application system 106. In some instances, the machine learning sub-system 404 may be implemented as an application or executable process that is executed on a computer system of the payment instrument application system 106. In an embodiment, the machine learning sub-system 404 implements an approval algorithm 406 that is configured to automatically, and dynamically, evaluate the applications submitted by users for new lines of credit, as well as these users' full credit histories as provided by the credit reporting service 110, to determine whether these users are approved for these new lines of credit. Further, the approval algorithm 406 may be configured to automatically, and dynamically, interact with the offer generation algorithm (e.g., offer generation algorithm 206, as described above in connection with FIGS. 2 and 3) to generate one or more offers corresponding to secured and/or unsecured dual-feature payment instruments that a particular user may be pre-qualified for.

The approval algorithm 406, in an embodiment, is a machine learning algorithm or artificial intelligence that is dynamically trained to process applications and user credit histories in order to determine whether users are approved for new lines of credit. For instance, the approval algorithm 406 may be implemented using a clustering algorithm that is trained to identify similar accounts and/or account holders (e.g., users) based on one or more vectors of similarity (e.g., credit scores, changes in credit scores, spending habits, total amount of credit allocated, total amount of credit available, payment performance, demographic information, etc.). These similar accounts and/or account holders may correspond to different payment instruments issued to these account holders and/or to applications that have been rejected based on the one or more vectors. In some instances, a dataset of characteristics of accounts and users may be analyzed using a clustering algorithm to determine whether to approve an application 116 submitted by the user 112 for a new line of credit associated with a particular payment instrument. The dataset of characteristics of accounts and users may, in an embodiment, include historical data corresponding to the applications for new lines of credit submitted by different users, the decisions made in response to these applications (e.g., approve or deny), the users' performance in maintaining the lines of credit associated with these payment instruments in good standing, historical changes to the users' credit scores while maintaining these lines of credit, and the like. Thus, the approval algorithm 406 may be trained using sample datasets of characteristics of accounts, users, and/or secured and unsecured dual-feature payment instruments to classify accounts, customers, and/or secured and unsecured dual-feature payment instruments in order to determine whether to approve or deny a submitted application 116 for a new line of credit associated with a particular payment instrument. These sample datasets may be generated based on information stored in the user accounts datastore 108.

In an embodiment, regardless of whether the user 112 is approved or rejected for a new line of credit associated with a particular dual-feature payment instrument, the approval algorithm 406 can determine whether new offers for other dual-feature payment instruments can be provided to the user 112. For instance, the approval algorithm 406 may transmit a request to the offer generation algorithm 206 to identify, based on the user's complete credit history, as well as historical data corresponding to the user 112 (including the current approval decision generated by the approval algorithm 406) and other users associated with the dual-feature payment instrument service, any new offers that may be presented to the user 112. If the offer generation algorithm 206 identifies any new offers for secured and/or unsecured dual-feature payment instruments that may be presented to the user 112, the offer generation algorithm 206 may provide these new offers to the approval algorithm 406.

In an embodiment, the approval algorithm 406 may automatically evaluate these new offers to determine whether to promote one or more of these new offers over the secured or unsecured dual-feature payment instrument that the user 112 has been approved for. For instance, based on the user's complete credit history and historical data corresponding to the user 112 and other users associated with the dual-feature payment instrument service 102, the approval algorithm 406 may determine whether an offer for a different secured or unsecured dual-feature payment instrument would be better suited for the user 112 (e.g., would provide a lesser likelihood of user default or of the user becoming delinquent on payments, would result in a greater improvement in the user's credit score, etc.). If the approval algorithm 406 identifies one or more offers for alternative secured and/or unsecured dual-feature payment instruments that may be better suited for the user 112, the approval algorithm 406 can automatically identify incentives for selecting an alternative secured or unsecured dual-feature payment instrument. For example, if the approval algorithm 406 determines that the user 112 is better suited for an alternative secured or unsecured dual-feature payment instrument, the approval algorithm 406 may identify one or more incentives that may entice the user 112 in applying for this alternative secured or unsecured dual-feature payment instrument. For instance, the approval algorithm 406 may use available data from the user accounts datastore 108 to determine what incentives the user 112 and other similarly situated users have historically taken advantage of for other dual-feature payment instruments.

Once the approval algorithm 406 has generated a decision with regard to the submitted application 116 and has identified (if any) new offers for lines of credit associated with different payment instruments that may be better suited for the user 112, the machine learning sub-system 404 may provide this decision and the identified new offers to the application processing sub-system 402. The application processing sub-system 402 may transmit a response to the user 112 that includes the decision made using the approval algorithm 406, as well as the identified new offers for lines of credit associated with different payment instruments that may be better suited for the user 112. For instance, if the approval algorithm 406 determines that the user 112 cannot be approved for the applied for line of credit, the application processing sub-system 402 may transmit a notification to the user 112 to indicate that the user 112 was not approved for the selected line of credit. Alternatively, if the approval algorithm 406 determines that the user 112 is approved for the selected line of credit, the application processing sub-system 402 may transmit a notification to the user 112 that they have been approved. Additionally, the application processing sub-system 402 may provide any related terms and conditions related to the selected secured or unsecured dual-feature payment instrument that the user 112 has been approved for. The application processing sub-system 402 may further present any new offers for alternative lines of credit and any incentives that may be used to entice the user 112 to apply for any of the alternative lines of credit in lieu of accepting originally applied for line of credit.

As noted above, if the user 112 has opted to accept a new line of credit associated with a particular dual-feature payment instrument, the payment instrument application system 106 may issue the secured dual-feature payment instrument 118 or the unsecured dual-feature payment instrument 120 to the user 112. Additionally, the machine learning sub-system 404 may monitor, in real-time, user accounts associated with the secured and unsecured dual-feature payment instruments issued by the payment instrument application system 106 to users. For instance, the machine learning sub-system 404 may update the dataset used to train the approval algorithm 406 in real-time as users utilize their secured and unsecured dual-feature payment instruments. Further, the machine learning sub-system 404 may monitor, in real-time, user repayment or delinquencies related to existing secured and unsecured dual-feature payment instruments, as well as usage of any benefits associated with these secured and unsecured dual-feature payment instruments. Thus, as the dataset maintained by the machine learning sub-system 404 is dynamically updated in real-time, the continuously updating dataset may be used to update the approval algorithm 406.

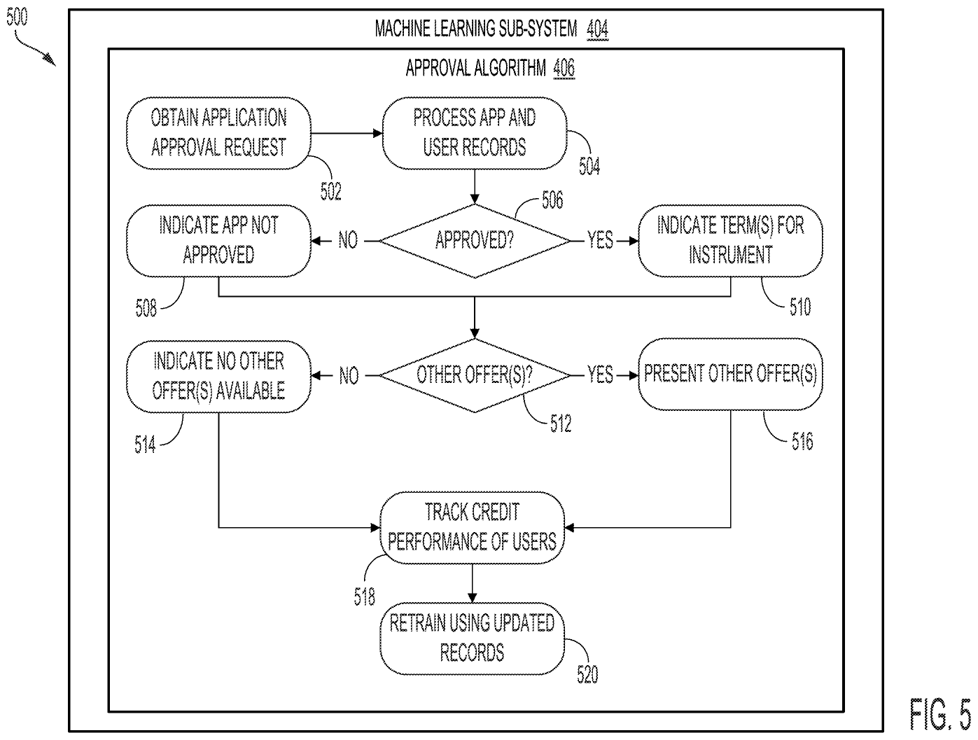

FIG. 5 shows an illustrative example of an environment 500 in which an approval algorithm 406 processes an application for a new line of credit, results from a full credit inquiry, and user records to automatically generate an approval determination and new offers for other lines of credit in accordance with at least one embodiment. As noted above, an application processing sub-system of the payment instrument application system may transmit a request to the machine learning sub-system 404 to obtain a decision regarding an application submitted by a user for a new line of credit associated with a secured or unsecured dual-feature payment instrument, as well as to identify any offers for other payment instruments that the user may be pre-qualified for and that may be better suited for the user based on the user's full credit history and other characteristics. The machine learning sub-system 404 may implement an approval algorithm 406 that is dynamically trained to automatically evaluate the applications submitted by users for new lines of credit, as well as these users' full credit histories, to determine whether these users are approved for these new lines of credit. Further, the approval algorithm 406 may automatically interact with the offer generation algorithm described above to generate one or more offers corresponding to secured and/or unsecured dual-feature payment instruments that may be better suited for these users.

At step 502, the approval algorithm 406 may receive an application approval request from the application processing sub-system. The approval request from the application processing sub-system may include the application submitted by a user for a new line of credit, as well as the result of the full credit inquiry provided by the credit reporting service to the application processing sub-system. As noted above, the result of the full credit inquiry may include, for the user, credit scores, changes in credit scores, spending habits, total amount of credit allocated, total amount of credit available, payment performance, demographic information, payment instruments issued, payment instruments in default, and the like.

At step 504, the approval algorithm 406 may process the provided application, the result of the full credit inquiry, and any existing user records from the user records datastore (such as user records datastore 108, described above in connection with FIG. 1) to determine, at step 506, whether the user is approved for the new line of credit. For instance, based on the user's full credit history, characteristics of the user (e.g., demographic information, etc.), and information provided in the application (e.g., current income, employment status, current employment title, length of employment, etc.), the approval algorithm 406 may identify similar-situated users according to one or more vectors of similarity (e.g., credit scores, changes in credit scores, spending habits, total amount of credit allocated, total amount of credit available, payment performance, demographic information, etc.). These similarly-situated users may correspond to different payment instruments issued to these account holders and/or to applications that have been rejected based on the one or more vectors of similarity. The approval algorithm 406, in some instances, may analyze a dataset of characteristics of users and accounts to determine whether to approve or reject the submitted application. This dataset, as described above, may include historical data corresponding to the applications for new lines of credit submitted by different users, the decisions made in response to these applications (e.g., approve or deny), the users' performance in maintaining the lines of credit associated with these payment instruments in good standing, historical changes to the users' credit scores while maintaining these lines of credit, and the like.

If the approval algorithm 406 determines that the user is not approved for the new line of credit, the approval algorithm 406, at step 508, may indicate that the user's application for the new line of credit has been rejected. For instance, the approval algorithm 406 may transmit a notification, through the application processing sub-system, to the user to indicate that the user has not been approved for the new line of credit. In some instances, the approval algorithm 406 may further provide the user with a rationale for the rejection of their application for the new line of credit. For example, if the user was rejected due to a poor credit score and a history of payment delinquencies, the approval algorithm 406 may generate a response that indicates that the poor credit score and the user's past history were contributing factors to the application being rejected. In some instances, any rationale provided may omit any specific metrics leading to rejection of the application. For example, the approval algorithm 406 may omit actual credit score values, descriptions of individual events corresponding to negative contributing factors towards rejection, and the like.

Alternatively, if the approval algorithm 406 determines that the user is approved for the new line of credit, the approval algorithm, at step 510, may indicate that the user's application for the new line of credit has been approved. For instance, the approval algorithm 406 may transmit a notification, through the application processing sub-system, to the user to indicate that the user has been approved for the new line of credit. The notification may include any terms and conditions related to the new line of credit (e.g., actual APR, amount of credit available, any applicable account fees, a required security deposit amount (for unsecured dual-feature payment instruments), etc.). Further, the notification may provide the user with an option to either accept the new line of credit or to reject the new line of credit.

Regardless of whether the approval algorithm 406 approves or rejects the application for the new line of credit, the approval algorithm 406, at step 512, may determine whether there are any other offers corresponding to other dual-feature payment instruments that the user may be pre-qualified for. As noted above, the approval algorithm 406 may transmit a request to the offer generation algorithm to identify, based on the user's complete credit history, as well as historical data corresponding to the user (including the current approval decision generated by the approval algorithm 406) and other users associated with the dual-feature payment instrument service, any new offers that may be presented to the user. If the offer generation algorithm identifies any new offers for secured and/or unsecured dual-feature payment instruments that may be presented to the user, the offer generation algorithm may provide these new offers to the approval algorithm 406.

As noted above, the approval algorithm 406 can automatically evaluate any new offers provided by the offer generation algorithm to determine whether to promote one or more of these offers over the secured or unsecured dual-feature payment instrument that the user has been approved for. For instance, based on the user's complete credit history and historical data corresponding to the user and other users, the approval algorithm 406 may determine whether an offer for a different secured or unsecured dual-feature payment instrument would be better suited for the user. If the approval algorithm 406 identifies one or more offers for alternative secured and/or unsecured dual-feature payment instruments that may be better suited for the user, the approval algorithm 406 can automatically identify incentives for selecting an alternative secured or unsecured dual-feature payment instrument. However, if the approval algorithm 406 determines that none of these new offers provide the user with a better option than the secured or unsecured dual-feature payment instrument that the user has been approved for, the approval algorithm 406 may forego presenting these new offers to the user.

If the approval algorithm 406 has not identified any offers that may be presented to the user in order to entice the user to accept one of these offers in place of accepting the new line of credit or as a consolation for being rejected for the new line of credit, the approval algorithm 406, at step 514, may indicate that no other offers are available to the user. For instance, the approval algorithm 406 may transmit a notification, through the application processing sub-system, to the user to indicate that no other offers are available to the user. Alternatively, the approval algorithm 406 may forego notifying the user with regard to the lack of other offers that may be available to the user. However, if the approval algorithm 406 has identified one or more offers that may be presented to the user in order to entice the user to accept any of these offers in lieu of accepting the new line of credit that the user was approved for or as a consolation for being rejected for the new line of credit, the approval algorithm 406, at step 516, may present these other offers to the user through the application processing sub-system. If the user opts to accept any of these other offers, the process illustrated in FIG. 5 may be restarted at step 502, whereby an application corresponding to a selected new offer may be processed by the approval algorithm 406.

At step 518, the approval algorithm 406 may track the credit performance of the various users associated with the dual-feature payment instrument service. For instance, the machine learning sub-system 404 may monitor, in real-time, user accounts associated with the secured and unsecured dual-feature payment instruments issued by the payment instrument application system to users. The machine learning sub-system 404 may update the dataset used to train the approval algorithm 406 in real-time as users utilize their secured and unsecured dual-feature payment instruments. Further, the machine learning sub-system 404 may monitor, in real-time, user repayment or delinquencies related to existing secured and unsecured dual-feature payment instruments, as well as usage of any benefits associated with these secured and unsecured dual-feature payment instruments. Thus, as the dataset maintained by the machine learning sub-system 404 is dynamically updated in real-time, the continuously updating dataset may be used, at step 520, to retrain the approval algorithm 406.

FIG. 6 shows an illustrative example of an environment 600 in which a user is presented with a set of offers 608 for different lines of credit associated with secured and unsecured payment instruments in response to a pre-qualification request in accordance with at least one embodiment. In the environment 600, a user may utilize a computing device 602 (e.g., a laptop computer, a desktop computer, a smartphone, etc.) to submit a pre-qualification request to a pre-qualification system 104 of the dual-feature payment instrument service 102. As noted above, the pre-qualification request may be submitted by the user to determine whether the user is pre-qualified for one or more payment instruments offered by the dual-feature payment instrument service 102. The user, in some examples, may submit the pre-qualification request in response to an advertisement associated with the dual-feature payment instrument service 102, in which one or more payment instruments are being advertised. In some instances, the user may submit a pre-qualification request out of their own volition. For example, the user may have an existing account with the dual-feature payment instrument service 102 and may wish to add a new line of credit to their account.

The pre-qualification request submitted by the user may include information that can be used to perform a soft inquiry of the user's credit report in order to determine whether the user can be pre-qualified for one or more lines of credit corresponding to one or more secured and/or unsecured dual-feature payment instruments. This information may include the user's legal name, birthdate, last four digits of their Social Security number, household income, employment history, employment status, and the like. In some instances, if the user has an existing account with the dual-feature payment instrument service 102, the pre-qualification system 104 may automatically retrieve any available information from the existing account and prompt the user for any additional information that may be required in order to perform the soft inquiry of the user's credit report. In some instances, the pre-qualification request may further indicate any user preferences corresponding to the secured and unsecured dual-feature payment instruments offered by the dual-feature payment instrument service 102. As noted above, the user may be presented with a listing or other catalog of the available payment instruments that the dual-feature payment instrument service provides. From this listing or other catalog, the user may select any preferences related to payment instruments that the user may be interested in. If the user submitted the pre-qualification request in response to an advertisement in which one or more payment instruments are being advertised, the pre-qualification request may automatically be associated with these one or more payment instruments, as selection of the advertisement may represent the user's preferences.

The pre-qualification system 104, in response to the pre-qualification request, may use the information provided in the pre-qualification request to automatically perform a soft credit inquiry through a credit reporting service. The result of the soft credit inquiry may include one or more credit scores associated with the user, the current amount of credit allocated to the user, the current amount of credit available to the user, any delinquencies or defaults associated with different lines of credit, repayment histories, and the like. In response to obtaining the result of the soft credit inquiry, the pre-qualification system 104 may use the result of the soft credit inquiry, the user's preferences (if any), and historical data corresponding to the user and other users associated with the dual-feature payment instrument service 102 as input to a machine learning algorithm or artificial intelligence (e.g., offer algorithm 206, as illustrated in FIG. 2) to identify one or more dual-feature payment instruments that the user is pre-qualified for and that may be offered to the user.

Based on the output of the machine learning algorithm or artificial intelligence, the pre-qualification system may provide, through an interface 604 (such as through a GUI associated with a browser application or a standalone application provided by the dual-feature payment instrument service 102 and implemented on the user device 602, etc.), a set of offers 608 corresponding to different secured and/or unsecured dual-feature payment instruments that the user is pre-qualified for. For each offer of the set of offers 608, the pre-qualification system 104 may provide information corresponding to the benefits associated with the corresponding payment instrument (e.g., discounts, cash back, loyalty rewards, etc.) and any financial terms that may be associated with the corresponding payment instrument (e.g., estimated APR, security deposit amount (if required), fees (e.g., annual fees, etc.), etc.). For example, as illustrated in FIG. 6, for a “Secured Rewards Card,” the pre-qualification system 104 has indicated that this particular payment instrument has a 6% APR and a required $500 security deposit. As another example, as illustrated in FIG. 6, for an “Unsecured Cash Back Card,” the pre-qualification system 104 may indicate that this particular payment instrument may have an APR between 13% and 18% (subject to a full credit inquiry) and a $90 annual fee. Thus, through the set of offers 608, the user may be able to compare the different payment instruments that the user may be pre-qualified for and determine whether to submit an application 116 for any of these offered payment instruments.

In an embodiment, if the user selects a particular offer from the set of offers 608, the pre-qualification system 104 may automatically update the interface 604 to provide additional information 606 associated with the selected offer. For instance, if the user selects an offer corresponding to the “Secured Rewards Card,” as illustrated in FIG. 6, the pre-qualification system 104 may update the interface 604 to provide additional information 606 that is associated with the “Secured Rewards Card.” This additional information 606 may include the information presented with the selected offer through the set of offers 608, as well as any applicable terms and conditions associated with the particular payment instrument corresponding to the selected offer. These applicable terms and conditions may include minimum payment requirements, penalties for failure to make timely payments, APRs associated with balance transfers and cash advances, any rules associated with loyalty rewards or cash back programs associated with the payment instrument, and the like. This may allow the user to better understand the parameters of the payment instrument that the user may be applying for.

Through the interface 604, the user may submit an application 116 to a payment instrument application system 106 to apply for a selected payment instrument. As noted above, the application 116 may provide the user's authorization to conduct a full credit inquiry to determine whether the user can be approved for the particular secured or unsecured dual-feature payment instrument selected by the user. The user may access the application 116 through the interface 604 provided by the pre-qualification system 104. In response to obtaining the application 116 from the user, the payment instrument application system 106 may determine whether the user is approved for a new line of credit associated with the selected secured or unsecured dual-feature payment instrument.

As noted above, the payment instrument application system 106 monitors, in real-time, user accounts associated with the secured and unsecured dual-feature payment instruments issued by the payment instrument application system 106 to users. For instance, the payment instrument application system 106 may automatically, and in real-time, monitor usage of secured and unsecured dual-feature payment instruments, user repayment or delinquency related to existing secured and unsecured dual-feature payment instruments, usage of any benefits associated with these secured and unsecured dual-feature payment instruments, and the like. As user accounts are updated in real-time according to user utilization of their secured and unsecured dual-feature payment instruments, these updated user accounts may be used to dynamically, and in real-time, update the machine learning algorithm or artificial intelligence implemented by the pre-qualification system 104 to determine which payment instruments a user may be pre-qualified for.

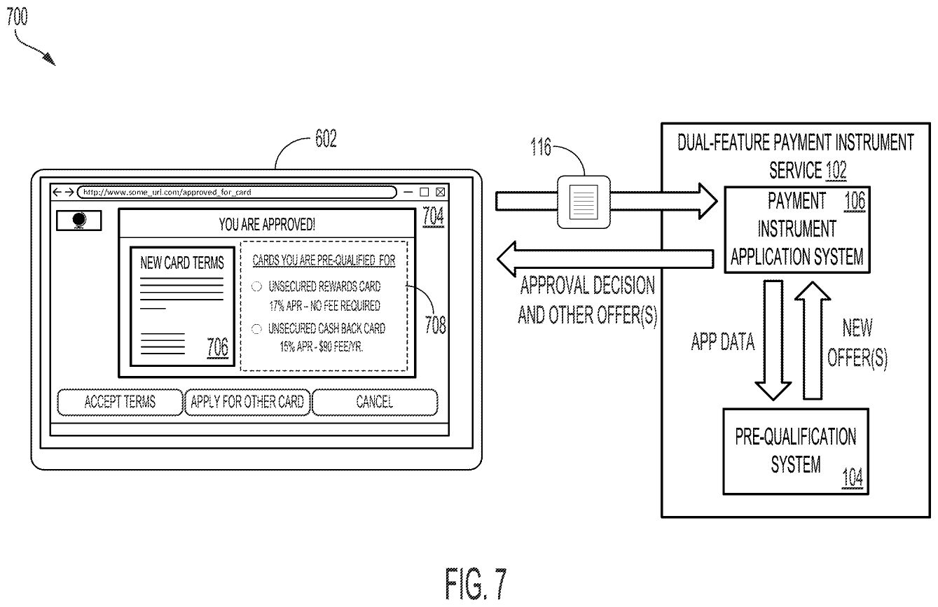

FIG. 7 shows an illustrative example of an environment 700 in which a user is presented with a set of terms 706 corresponding to a new line of credit the user applied for and a set of offers 708 for different lines of credit associated with secured and unsecured payment instruments in response to an application 116 to establish the new line of credit in accordance with at least one embodiment. In the environment 700, a user may utilize a computing device 602 to submit an application 116 for a new line of credit associated with a particular secured or unsecured dual-feature payment instrument. As noted above, the application 116 may provide the user's authorization to conduct a full credit inquiry to determine whether the user can be approved for the particular secured or unsecured dual-feature payment instrument selected by the user. In some instances, the user may access the application through the interface 604 described above in connection with FIG. 6 and provided by the pre-qualification system 104.

As noted above, in response to receiving an application 116 for a new line of credit associated with a particular payment instrument, the payment instrument application system 106 may automatically submit a full credit inquiry to a credit reporting service. The full credit inquiry may result in a complete credit evaluation for the user. Similar to the soft credit inquiry described above, the result of the full credit inquiry may include credit scores, changes in credit scores, spending habits, total amount of credit allocated, total amount of credit available, payment performance, demographic information, payment instruments issued, payment instruments in default, and the like.

In an embodiment, in response to obtaining a complete credit evaluation for the user, the payment instrument application system 106 may use a machine learning algorithm or artificial intelligence to determine whether the user is approved for the new line of credit and to identify any offers for other lines of credit that may be better suited for the user. The machine learning algorithm or artificial intelligence may be implemented to automatically, and dynamically, evaluate the applications submitted by users for new lines of credit, as well as these users' full credit histories as provided by the credit reporting service, to determine whether these users are approved for these new lines of credit. Further, the machine learning algorithm or artificial intelligence may be configured to automatically, and dynamically, interact with the pre-qualification system 104 to generate one or more offers corresponding to secured and/or unsecured dual-feature payment instruments that a particular user may be pre-qualified for and that may be better suited for the user (e.g., less likely to result in delinquency and/or default, more likely to increase the user's credit scores over time, etc.).

Regardless of whether the application submitted by the user is approved or rejected by the machine learning algorithm or artificial intelligence, the payment instrument application system 106 may use the machine learning algorithm or artificial intelligence to determine whether new offers for other dual-feature payment instruments can be provided to the user. For instance, the machine learning algorithm or artificial intelligence may transmit a request to the pre-qualification system 104 to identify, based on the user's complete credit history, as well as historical data corresponding to the user (including the current approval decision) and other users associated with the dual-feature payment instrument service 102, any new offers that may be presented to the user. If the pre-qualification system 104 identifies any new offers for secured and/or unsecured dual-feature payment instruments that may be presented to the user, the pre-qualification system 104 may provide these new offers to the payment instrument application system 106, which may use the machine learning algorithm or artificial intelligence to evaluate these new offers and determine whether to promote one or more of these new offers over the secured or unsecured dual-feature payment instrument that the user has been approved for. For instance, based on the user's complete credit history and historical data corresponding to the user and other users associated with the dual-feature payment instrument service 102, the machine learning algorithm or artificial intelligence may determine whether an offer for a different secured or unsecured dual-feature payment instrument would be better suited for the user (e.g., would provide a lesser likelihood of user default or of the user becoming delinquent on payments, would result in a greater improvement in the user's credit score, etc.).

If the machine learning algorithm or artificial intelligence implemented by the payment instrument application system 106 identifies one or more offers for alternative secured and/or unsecured dual-feature payment instruments that may be better suited for the user, the machine learning algorithm or artificial intelligence may automatically identify incentives that may entice the user to apply for any of these alternative secured and/or unsecured dual-feature payment instruments. The machine learning algorithm or artificial intelligence may use available data corresponding to the user and other similarly situated users to identify what incentives the user and other similarly situated users have historically taken advantage of for other dual-feature payment instruments.

Once the payment instrument application system 106 has obtained a decision with regard to the submitted application 116 and has identified (if any) new offers for lines of credit associated with different payment instruments that may be better suited for the user, the payment instrument application system 106 may update an interface 704 presented via the computing device 602 to provide the user with the decision and the new offers (if any) for lines of credit that may be better suited for the user. For instance, as illustrated in FIG. 7 and through the interface 704, the payment instrument application 106 may indicate the decision corresponding to the submitted application 116 (e.g., “You Are Approved!”). If the user is approved for the new line of credit that they applied for, the payment instrument application system 106 may provide the user, through the interface 704, with any applicable terms and conditions 706 related to new line of credit. These terms and conditions 706 may include minimum payment requirements, penalties for failure to make timely payments, APRs associated with balance transfers and cash advances, any rules associated with loyalty rewards or cash back programs associated with the payment instrument, and the like. Further, the terms and conditions 706 may include any other disclosures required by law. It should be noted that if the user is not approved for the new line of credit that they applied for, the payment instrument application system 106 may forego presenting these terms and conditions 706.

In addition to providing the terms and conditions 706 corresponding to the new line of credit (if the user is approved for the new line of credit), the payment instrument application system 106 may present a set of offers 708 corresponding to different secured and/or unsecured dual-feature payment instruments that the user is pre-qualified for and that the payment instrument application system 106 has determined may be better suited for the user. Similar to the set of offers 608 described above in connection with FIG. 6, for each offer of the set of offers 708, the payment instrument application system 106 may provide information corresponding to the benefits associated with the corresponding payment instrument (e.g., discounts, cash back, loyalty rewards, etc.) and any financial terms that may be associated with the corresponding payment instrument (e.g., estimated APR, security deposit amount (if required), fees (e.g., annual fees, etc.), etc.). Additionally, for each offer of the set of offers 708, the payment instrument application system 106 may provide information corresponding to the incentives made available to the user if the user opts to accept the offer (e.g., apply for a payment instrument corresponding to the offer) instead of accepting the terms and conditions 706 corresponding to the payment instrument the user originally applied for.

As noted above, if the user has opted to accept the terms and conditions 706 associated with the new line of credit that the user has been approved for, the payment instrument application system 106 may issue a corresponding dual-feature payment instrument to the user. However, if the user opts to apply for a new line of credit associated with an offer provided with the set of offers 708, the payment instrument application system 106 may update the interface 704 to enable the user to submit another application to the payment instrument application system 106 to apply for a selected payment instrument. In response to obtaining this application from the user, the payment instrument application system 106 may determine whether the user is approved for a new line of credit associated with this alternative secured or unsecured dual-feature payment instrument. The operations performed by the payment instrument application system 106 may be similar to those performed in response to obtaining the application 116, described above.

The payment instrument application system 106, in an embodiment, monitors, in real-time, user accounts associated with the secured and unsecured dual-feature payment instruments issued by the payment instrument application system 106 to users. For instance, the payment instrument application system 106 may update the dataset used to train the machine learning algorithm or artificial intelligence implemented by the payment instrument application system 106 in real-time as users utilize their secured and unsecured dual-feature payment instruments. Further, the payment instrument application system 106 may monitor, in real-time, user repayment or delinquencies related to existing secured and unsecured dual-feature payment instruments, as well as usage of any benefits associated with these secured and unsecured dual-feature payment instruments. Thus, this continuously updating dataset may be used to dynamically, and in real-time, update the machine learning algorithm or artificial intelligence used for application decisioning processes and for identifying alternative offers that may be better suited for users.

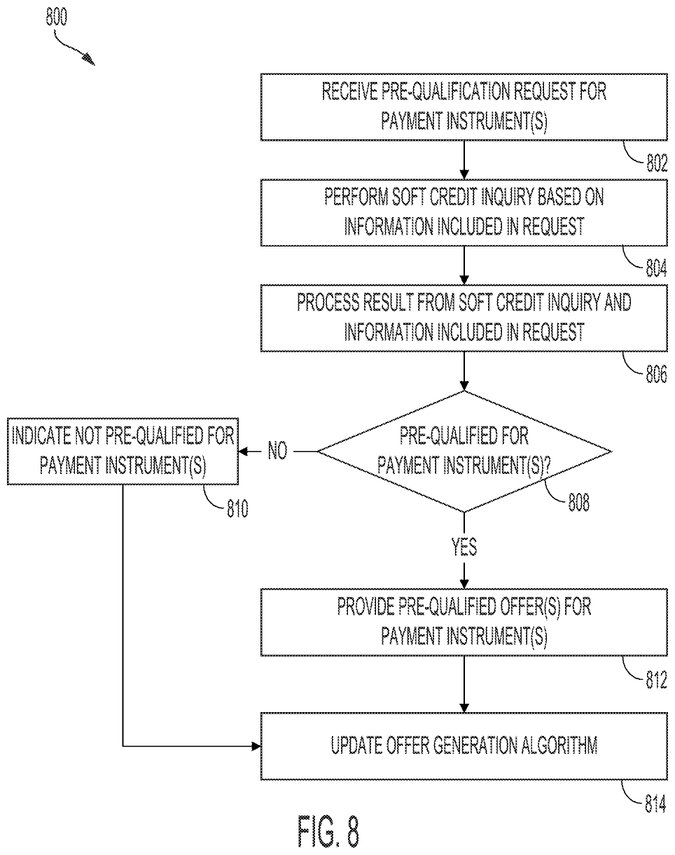

FIG. 8 shows an illustrative example of a process 800 for generating and providing one or more pre-qualification offers for lines of credit associated with secured and unsecured payment instruments in accordance with at least one embodiment. The process 800 may be performed by a pre-qualification system associated with a dual-feature payment instrument service. As noted above, the pre-qualification system is implemented to process incoming pre-qualification requests from users in order to perform soft credit inquiries and, based on these inquiries, identify any secured and/or unsecured dual-feature payment instruments that these users may be pre-qualified for.

At step 802, the pre-qualification system may receive a pre-qualification request to identify one or more secured and/or unsecured dual-feature payment instruments that a user may be pre-qualified for. The pre-qualification request may include information that can be used to perform a soft inquiry of a user's credit report in order to determine whether the user is pre-qualified for one or more lines of credit associated with different payment instruments offered by the dual-feature payment instrument service. For instance, through the pre-qualification request, a user may provide their legal name, birthdate, last four digits of their Social Security number, household income, employment history, employment status, and the like. In some instances, if the user has an existing account associated with the dual-feature payment instrument service, the user may provide a set of credentials associated with the existing account (e.g., username, password, cryptographic token(s), etc.) that may be validated by the pre-qualification system and used to access the existing account. This may allow the pre-qualification system to automatically retrieve any information required to perform the soft inquiry of the user's credit report. In some instances, if the requisite information cannot be obtained from the user's existing account, the pre-qualification system may prompt the user for the required information.

At step 804, the pre-qualification system may perform a soft credit inquiry based on the information included in the pre-qualification request and/or from an existing user account. For instance, the pre-qualification system may automatically submit a soft credit inquiry to a credit reporting service to obtain a preliminary credit evaluation for the user. The result of the soft credit inquiry may include one or more credit scores associated with the user, the current amount of credit allocated to the user, the current amount of credit available to the user, any delinquencies or defaults corresponding to different lines of credit, and the like.

At step 806, the pre-qualification system may process the result from the soft credit inquiry and the information included in the pre-request and/or from an existing user account. As noted above, the pre-qualification system may implement an offer generation algorithm that is dynamically trained to identify one or more payment instruments that may be offered to a user based on the result of the soft credit inquiry, the user's preferences (if any), and historical data corresponding to the user and other users associated with the dual-feature payment instrument service. The historical data may include historical transaction and application records for various users (past and present) to whom secured and unsecured dual-feature payment instruments have been issued. Further, the historical transaction and application records may include information corresponding to credit scores, changes in credit scores, spending habits, total amounts of credit allocated, total amounts of credit available, payment performance, and the like for each of these users. In some instances, the offer generation algorithm may obtain, in real-time, application records generated by the payment instrument application system as the payment instrument application system processes new applications for lines of credit associated with different secured and unsecured dual-feature payment instruments. These application records may similarly include the aforementioned information, as well as application determinations (e.g., approve or deny) generated by the payment instrument application system.

At step 808, the pre-qualification system may determine whether the user is pre-qualified for one or more secured and/or unsecured dual-feature payment instruments. For instance, based on the output of the offer generation algorithm, the pre-qualification system may determine what secured and unsecured dual-feature payment instruments may be offered to the user. If the pre-qualification system determines that the user is not pre-qualified for any payment instruments offered by the dual-feature payment instrument service, the pre-qualification system, at step 810, may indicate that the user is not pre-qualified for any of these payment instruments. For instance, the pre-qualification system may transmit a notification to the user (such as through an interface, as described above in connection with FIG. 6) to indicate that the user is not pre-qualified for any available payment instruments.

If the pre-qualification system determine that the user is pre-qualified for one or more secured and/or unsecured dual-feature payment instruments, the pre-qualification system, at step 812, may provide any associated pre-qualified offers for these payment instruments to the user. For instance, the pre-qualification system may provide, to the user (such as through the aforementioned interface), a listing of secured and/or unsecured dual-feature payment instruments that the user may be pre-qualified for, as well as details corresponding to the benefits of these payment instruments and any financial terms that may be associated with these payment instruments. For example, if the user is pre-qualified for a secured dual-feature payment instrument, the pre-qualification system may provide the user with an indication corresponding to an amount required as a security deposit for the secured dual-feature payment instrument, as well as a range corresponding to the interest rates that may be associated with the secured dual-feature payment instrument. Further, the pre-qualification system may provide, for offers corresponding to any of the payment instruments the user is pre-qualified for, information corresponding to any benefits associated with these payment instruments, such as an amount of cash back for purchases, loyalty rewards points for purchases, discounts, free credit monitoring, and the like.

At step 814, the pre-qualification system may update the offer generation algorithm based on feedback obtained from the user, such as through selection of a presented offer. For instance, the pre-qualification system may provide the offer generation algorithm with one or more offer selections made by the user through the payment instrument application system. For instance, if a user opts to apply for one or more secured and/or unsecured dual-feature payment instruments recommended by the offer generation algorithm, or decides to reject the recommendations provided by the offer generation algorithm, the pre-qualification system may incorporate this feedback into the dataset used to train the offer generation algorithm. This feedback may be obtained automatically from the payment instrument application system, which may process, in real-time, applications for new lines of credit corresponding to different payment instruments. The data from the payment instrument application system may include identifying information associated with the user (e.g., user's legal name, user's physical address, etc.), the payment instruments recommended to the user, and the user's actual selection of a payment instrument in their application. Using the identifying information associated with the user, the dataset used to train the offer generation algorithm may be updated to incorporate the user's feedback with regard to the payment instrument offers recommended to the user.

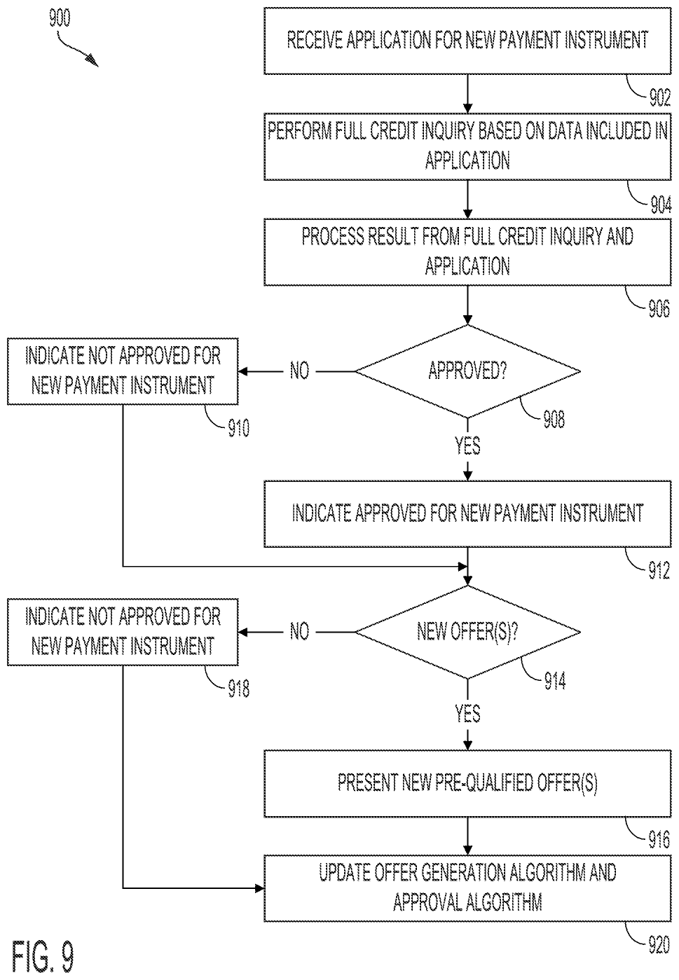

FIG. 9 shows an illustrative example of a process 900 for generating an application determination and new offers for other lines of credit associated with secured and unsecured payment instruments in accordance with at least one embodiment. The process 900 may be performed by a payment instrument application system associated with a dual-feature payment instrument service. As noted above, the payment instrument application system is implemented to process incoming applications for new lines of credit to determine users may be approved for these lines of credit. Further, the payment instrument application system may be implemented to automatically generate new offers for other lines of credit that may be better suited for these users.

At step 902, the payment instrument application system may receive an application for a new line of credit associated with a particular payment instrument (e.g., a secured dual-feature payment instrument, an unsecured dual-feature payment instrument, etc.). Similar to the pre-qualification request described above, an application for a new line of credit may include a user's legal name, birthdate, last four digits of their Social Security number, household income, employment history, employment status, and the like. Further, the application may provide the user's authorization to conduct a full credit inquiry, which may be used to determine whether the user can be approved for the new line of credit that the user has applied for.

At step 904, the payment instrument application system may perform a full credit inquiry based on the data included in the application. For instance, the payment instrument application system may automatically submit a full credit inquiry to a credit reporting service in order to obtain a complete credit evaluation for the user. This complete credit evaluation may indicate the user's credit scores, changes in credit scores, spending habits, total amount of credit allocated, total amount of credit available, payment performance, demographic information, the number and types payment instruments issued, any payment instruments in default, and the like.

At step 906, the payment instrument application system may process the result from the full credit inquiry (e.g., the complete credit evaluation) and the received application to determine, at step 908, whether the user is approved for the new line of credit. As noted above, the payment instrument application system may implement an approval algorithm (e.g., approval algorithm 406 described above in connection FIGS. 4-5) that is configured to automatically, and dynamically, evaluate the applications submitted by users for new lines of credit, as well as these users' full credit histories as provided by the credit reporting service, to determine whether these users are approved for these new lines of credit. As described in further detail herein, the approval algorithm is also configured to automatically, and dynamically, interact with an offer generation algorithm (e.g., offer generation algorithm 206, as described above in connection with FIGS. 2-3) to generate one or more offers corresponding to other payment instruments that the user may be pre-qualified for and that may provide the user with a better option compared to the new line of credit the user has applied for.

If the payment instrument application system, through use of the approval algorithm, determines that the user is not approved for the new line of credit that the user applied for, the payment instrument application system, at step 910, may indicate that the user has not been approved for the new line of credit. For instance, the payment instrument application system may transmit a notification to the user to indicate that the user has not been approved for the new line of credit. In some instances, the payment instrument application system may further provide the user with a rationale for the rejection of their application for the new line of credit. For example, if the user was rejected due to a poor credit score and a history of payment delinquencies, the payment instrument application system may generate a response that indicates that the poor credit score and the user's past history were contributing factors to the application being rejected. In some instances, any rationale provided may omit any specific metrics leading to rejection of the application. For example, the payment instrument application system may omit actual credit score values, descriptions of individual events corresponding to negative contributing factors towards rejection, and the like.

However, if the payment instrument application system determines, using the approval algorithm, that the user is approved for the new line of credit that the user applied for, the payment instrument application system, at step 912, may indicate that the user has been approved for the new line of credit. For instance, the payment instrument application system may transmit a notification to the user to indicate that the user has been approved for the new line of credit. The notification may include any terms and conditions related to the new line of credit (e.g., actual APR, amount of credit available, any applicable account fees, a required security deposit amount (for unsecured dual-feature payment instruments), etc.). Further, the notification may provide the user with an option to either accept the new line of credit or to reject the new line of credit.

At step 914, the payment instrument application system may determine whether there are any new offers for lines of credit that the user is pre-qualified for and that may be better suited or appealing to the user. This determination may be performed regardless of whether the user is approved for the new line of credit that the user has applied for. For instance, the payment instrument application system may transmit a request to the pre-qualification system to determine whether the user is pre-qualified for one or more other lines of credit associated with other available payment instruments offered by the dual-feature payment instrument service. The request may include the user's complete credit history (as obtained from the credit reporting service) and historical data corresponding to the user (including the approval decision corresponding to the received application). In response to the request, the pre-qualification system may use the user's complete credit history, the historical data corresponding to the user, and historical data corresponding to other users associated with the dual-feature payment instrument service as input to the offer generation algorithm to identify any payment instruments that the user may be pre-qualified for. If the offer generation algorithm identifies one or more payment instruments that the user may be pre-qualified for, the offer generation algorithm may provide offers corresponding to these one or more payment instruments to the payment instrument application system.

If the payment instrument application system obtains one or more offers from the pre-qualification system, the payment instrument application system may automatically evaluate these offers to determine whether to promote one or more of these offers over the line of credit that the user has been approved for. For instance, based on the user's complete credit history and historical data corresponding to the user and other users, the payment instrument application system may determine whether an offer for a different line of credit would be better suited for the user (e.g., would provide a lesser likelihood of user default or of the user becoming delinquent on payments, would result in a greater improvement in the user's credit score, etc.). If the payment instrument application system identifies one or more offers for alternative lines of credit that may be better suited for the user, the payment instrument application system can automatically identify incentives for selecting an alternative secured or unsecured dual-feature payment instrument. For instance, the payment instrument application system may use available data associated with the user and other similarly situated users to determine what incentives the user and the other similarly situated users have historically taken advantage of for other dual-feature payment instruments. These incentives may include a reduced APR for a limited time, increased cash back percentages or amounts for a limited time, greater loyalty rewards, greater discounts, and the like.

At step 916, if the payment instrument application system identifies one or more offers for lines of credit that may be better suited for the user, the payment instrument application system may present these one or more offers to the user. For instance, the payment instrument application system may present, through an interface available to the user, a set of offers corresponding to the different secured and/or unsecured dual-feature payment instruments that the user is pre-qualified for and that the payment instrument application system has determined may be better suited for the user. For each offer of the set of offers, the payment instrument application system may provide information corresponding to the benefits associated with the corresponding payment instrument (e.g., discounts, cash back, loyalty rewards, etc.) and any financial terms that may be associated with the corresponding payment instrument (e.g., estimated APR, security deposit amount (if required), fees (e.g., annual fees, etc.), etc.). Additionally, for each offer of the set of offers, the payment instrument application system may provide information corresponding to the incentives made available to the user if the user opts to accept the offer (e.g., apply for a payment instrument corresponding to the offer) instead of accepting the line of credit that the user originally applied for.

If the payment instrument application system does not identify any offers that may be presented to the user in order to entice the user to accept one of these offers in place of accepting the new line of credit or as a consolation for being rejected for the new line of credit, the payment instrument application system, at step 918, may indicate that no other offers are available to the user. For instance, the payment instrument application system may transmit a notification to the user to indicate that no other offers are available to the user. In some instances, rather than providing the user with an indication that no other offers are available to the user, the payment instrument application system may forego notifying the user with regard to the absence of any available offers.

At step 920, regardless of whether the user is approved for the new line of credit and/or provided with others offers for alternative lines of credit, the payment instrument application system may update the offer generation algorithm implemented by the pre-qualification system and the approval algorithm implemented by the payment instrument application system. As noted above, the payment instrument application system may track the credit performance of various users associated with the dual-feature payment instrument service, including the user that submitted the application (if the user maintains at least one active account with the dual-feature payment instrument service). For instance, the payment instrument application system may monitor, in real-time, user accounts associated with the secured and unsecured dual-feature payment instruments issued by the payment instrument application system to users. The payment instrument application system may update the dataset used to train the approval algorithm and the offer generation algorithm in real-time as users utilize their secured and unsecured dual-feature payment instruments. Further, the payment instrument application system may monitor, in real-time, user repayment or delinquencies related to existing secured and unsecured dual-feature payment instruments, as well as usage of any benefits associated with these secured and unsecured dual-feature payment instruments. Thus, as the dataset maintained by the payment instrument application system is dynamically updated in real-time, the continuously updating dataset may be used, at step 920, to update (e.g., retrain and/or reinforce) the offer generation algorithm and the approval algorithm.

FIG. 10 illustrates a computing system architecture 1000, including various components in electrical communication with each other, in accordance with some embodiments. The example computing system architecture 1000 illustrated in FIG. 10 includes a computing device 1002, which has various components in electrical communication with each other using a connection 1006, such as a bus, in accordance with some implementations. The example computing system architecture 1000 includes a processing unit 1004 that is in electrical communication with various system components, using the connection 1006, and including the system memory 1014. In some embodiments, the system memory 1014 includes read-only memory (ROM), random-access memory (RAM), and other such memory technologies including, but not limited to, those described herein. In some embodiments, the example computing system architecture 1000 includes a cache 1008 of high-speed memory connected directly with, in close proximity to, or integrated as part of the processor 1004. The system architecture 1000 can copy data from the memory 1014 and/or the storage device 1010 to the cache 1008 for quick access by the processor 1004. In this way, the cache 1008 can provide a performance boost that decreases or eliminates processor delays in the processor 1004 due to waiting for data. Using modules, methods and services such as those described herein, the processor 1004 can be configured to perform various actions. In some embodiments, the cache 1008 may include multiple types of cache including, for example, level one (L1) and level two (L2) cache. The memory 1014 may be referred to herein as system memory or computer system memory. The memory 1014 may include, at various times, elements of an operating system, one or more applications, data associated with the operating system or the one or more applications, or other such data associated with the computing device 1002.

Other system memory 1014 can be available for use as well. The memory 1014 can include multiple different types of memory with different performance characteristics. The processor 1004 can include any general purpose processor and one or more hardware or software services, such as service 1012 stored in storage device 1010, configured to control the processor 1004 as well as a special-purpose processor where software instructions are incorporated into the actual processor design. The processor 1004 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1004 can be a microprocessor, a microcontroller, a digital signal processor (“DSP”), or a combination of these and/or other types of processors. In some embodiments, the processor 1004 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1000, an input device 1016 can represent any number of input mechanisms, such as a microphone for speech, a touch-sensitive screen for gesture or graphical input, keyboard, mouse, motion input, pen, and other such input devices. An output device 1018 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1000. In some embodiments, the input device 1016 and/or the output device 1018 can be coupled to the computing device 1002 using a remote connection device such as, for example, a communication interface such as the network interface 1020 described herein. In such embodiments, the communication interface can govern and manage the input and output received from the attached input device 1016 and/or output device 1018. As may be contemplated, there is no restriction on operating on any particular hardware arrangement and accordingly the basic features here may easily be substituted for other hardware, software, or firmware arrangements as they are developed.

In some embodiments, the storage device 1010 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1010 can include hardware and/or software services such as service 1012 that can control or configure the processor 1004 to perform one or more functions including, but not limited to, the methods, processes, functions, systems, and services described herein in various embodiments. In some embodiments, the hardware or software services can be implemented as modules. As illustrated in example computing system architecture 1000, the storage device 1010 can be connected to other parts of the computing device 1002 using the system connection 1006. In an embodiment, a hardware service or hardware module such as service 1012, that performs a function can include a software component stored in a non-transitory computer-readable medium that, in connection with the necessary hardware components, such as the processor 1004, connection 1006, cache 1008, storage device 1010, memory 1014, input device 1016, output device 1018, and so forth, can carry out the functions such as those described herein.

The disclosed dual-feature payment instrument service, the systems of the dual-feature payment instrument service, and the systems and methods for graduating a secured dual-feature payment instrument to an unsecured dual-feature payment instrument can be performed using a computing system such as the example computing system illustrated in FIG. 10, using one or more components of the example computing system architecture 1000. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for graduating a secured dual-feature payment instrument to an unsecured dual-feature payment instrument described herein by, for example, executing code using a processor such as processor 1004 wherein the code is stored in memory such as memory 1014 as described herein. One or more of a user device, a provider server or system, a database system, or other such devices, services, or systems may include some or all of the components of the computing system such as the example computing system illustrated in FIG. 10, using one or more components of the example computing system architecture 1000 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1028. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1004 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1014 can be coupled to the processor 1004 by, for example, a connector such as connector 1006, or a bus. As used herein, a connector or bus such as connector 1006 is a communications system that transfers data between components within the computing device 1002 and may, in some embodiments, be used to transfer data between computing devices. The connector 1006 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1014 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1014 can also include magnetic or optical data storage media including read-only (e.g., CD ROM and DVD ROM) or otherwise (e.g., CD or DVD). The memory can be local, remote, or distributed.

As described herein, the connector 1006 (or bus) can also couple the processor 1004 to the storage device 1010, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1010. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1006 can also couple the processor 1004 to a network interface device such as the network interface 1020. The interface can include one or more of a modem or other such network interfaces including, but not limited to those described herein. It will be appreciated that the network interface 1020 may be considered to be part of the computing device 1002 or may be separate from the computing device 1002. The network interface 1020 can include one or more of an analog modem, Integrated Services Digital Network (ISDN) modem, cable modem, token ring interface, satellite transmission interface, or other interfaces for coupling a computer system to other computer systems. In some embodiments, the network interface 1020 can include one or more input and/or output (I/O) devices. The I/O devices can include, by way of example but not limitation, input devices such as input device 1016 and/or output devices such as output device 1018. For example, the network interface 1020 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1002 can be connected to one or more additional computing devices such as computing device 1024 via a network 1022 using a connection such as the network interface 1020. In such embodiments, the computing device 1024 may execute one or more services 1026 to perform one or more functions under the control of, or on behalf of, programs and/or services operating on computing device 1002. In some embodiments, a computing device such as computing device 1024 may include one or more of the types of components as described in connection with computing device 1002 including, but not limited to, a processor such as processor 1004, a connection such as connection 1006, a cache such as cache 1008, a storage device such as storage device 1010, memory such as memory 1014, an input device such as input device 1016, and an output device such as output device 1018. In such embodiments, the computing device 1024 can carry out the functions such as those described herein in connection with computing device 1002. In some embodiments, the computing device 1002 can be connected to a plurality of computing devices such as computing device 1024, each of which may also be connected to a plurality of computing devices such as computing device 1024. Such an embodiment may be referred to herein as a distributed computing environment.

The network 1022 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1022 can be wired connections, wireless connections, or combinations thereof. Communications via the network 1022 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1022, within the computing device 1002, within the computing device 1024, or within the computing resources provider 1028 can include information, which also may be referred to herein as content. The information may include text, graphics, audio, video, haptics, and/or any other information that can be provided to a user of the computing device such as the computing device 1002. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1002 and presented to a user of the computing device 1002 using forms that are perceptible via sight, sound, smell, taste, touch, or other such mechanisms. In some embodiments, communications over the network 1022 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1002 and/or the computing device 1024 can be connected to a computing resources provider 1028 via the network 1022 using a network interface such as those described herein (e.g. network interface 1020). In such embodiments, one or more systems (e.g., service 1030 and service 1032) hosted within the computing resources provider 1028 (also referred to herein as within “a computing resources provider environment”) may execute one or more services to perform one or more functions under the control of, or on behalf of, programs and/or services operating on computing device 1002 and/or computing device 1024. Systems such as service 1030 and service 1032 may include one or more computing devices such as those described herein to execute computer code to perform the one or more functions under the control of, or on behalf of, programs and/or services operating on computing device 1002 and/or computing device 1024.

For example, the computing resources provider 1028 may provide a service, operating on service 1030 to store data for the computing device 1002 when, for example, the amount of data that the computing device 1002 exceeds the capacity of storage device 1010. In another example, the computing resources provider 1028 may provide a service to first instantiate a virtual machine (VM) on service 1032, use that VM to access the data stored on service 1032, perform one or more operations on that data, and provide a result of those one or more operations to the computing device 1002. Such operations (e.g., data storage and VM instantiation) may be referred to herein as operating “in the cloud,” “within a cloud computing environment,” or “within a hosted virtual machine environment,” and the computing resources provider 1028 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1028 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1030 and service 1032 may implement versions of various services (e.g., the service 1012 or the service 1026) on behalf of, or under the control of, computing device 1002 and/or computing device 1024. Such implemented versions of various services may involve one or more virtualization techniques so that, for example, it may appear to a user of computing device 1002 that the service 1012 is executing on the computing device 1002 when the service is executing on, for example, service 1030. As may also be contemplated, the various services operating within the computing resources provider 1028 environment may be distributed among various systems within the environment as well as partially distributed onto computing device 1024 and/or computing device 1002.

In an embodiment, the computing device 1002 can be connected to one or more additional computing devices and/or services such as merchant computing device 1036 and/or a point-of-sale service 1034 via the network 1022 and using a connection such as the network interface 1020. In an embodiment, the point-of-sale service 1034 is separate from the merchant computing device 1036. In an embodiment, the point-of-sale service 1034 is executing on the merchant computing device 1036. In an embodiment, the point-of-sale service 1034 is executing as one or more services (e.g., the service 1030 and/or the service 1032) operating within the environment of the computing resources provider. As used herein, a point-of-sale service 1034 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 1036 to interact with the point-of-sale service 1034. In an embodiment, the merchant computing device 1036 is a dedicated point-of-service (POS) terminal. In an embodiment, the merchant computing device 1036 is a cash register system. In an embodiment, the merchant computing device 1036 is an application or web service operating on a computing device such as the computing device 1002 described herein. In such an embodiment, the application or web service may be provided by a financial services system (e.g., a bank, a transaction processing system, an inventory management system, or some other such financial services system). In an embodiment, the merchant computing device 1036 includes an auxiliary device or system to execute tasks associated with the point-of-sale service 1034 (e.g., a payment instrument processing device attached to a smart phone or tablet). In an embodiment, the merchant computing device 1036 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 1036 is a virtual device (e.g., a virtual kiosk) such as the virtual devices described herein. Although not illustrated here, in an embodiment, the merchant computing device 1036 may be one of a plurality of devices that may be interconnected using a network such as the network 1022.

In an embodiment, the computing device 1002 can be connected to one or more additional computing devices and/or services such as a payment instrument service 1038 via the network 1022 and using a connection such as the network interface 1020. In an embodiment, the payment instrument service 1038 connects directly with the point of sale service 1034. In an embodiment, elements of the payment instrument service 1038 are executing on the merchant computing device 1036. In an embodiment, the payment instrument service 1038 is executing as one or more services (e.g., the service 1030 and/or the service 1032) operating within the environment of the computing resources provider. As used herein, a payment instrument service 1038 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 1038 are running as an application or web service operating on a computing device such as the computing device 1002 described herein. In such an embodiment, the application or web service of the payment instrument service 1038 may be provided by a financial services system (e.g., a bank, a transaction processing system, an inventory management system, or some other such financial services system). In an embodiment, elements of the payment instrument service 1038 are running on an auxiliary device or system configured to execute tasks associated with the payment instrument service 1038 (e.g., uses a payment instrument processing device attached to a smart phone or tablet). In an embodiment, elements of the payment instrument service 1038 are running on virtual device such as those described herein. Although not illustrated here, in an embodiment, the payment instrument service 1038 may be running on one or more of a plurality of devices that may be interconnected using a network such as the network 1022.

In an embodiment, the computing device 1002 can be connected to one or more additional computing devices and/or services such as an authentication service 1040 via the network 1022 and using a connection such as the network interface 1020. In an embodiment, the authentication service 1040 is an element of the payment instrument service 1038. In an embodiment, the authentication service 1040 is separate from the payment instrument service 1038. In an embodiment, the authentication service 1040 connects directly with the point of sale service 1034. In an embodiment, elements of the authentication service 1040 are executing on the merchant computing device 1036. In an embodiment, the authentication service 1040 is executing as one or more services (e.g., the service 1030 and/or the service 1032) operating within the environment of the computing resources provider. As used herein, an authentication service 1040 is a service used by one or more merchants to authenticate transactions associated with payment instruments. An authentication service may be a third-party service that provides secure and verified authorization of the transactions.

In an embodiment, elements of the authentication service 1040 are running as an application or web service operating on a computing device such as the computing device 1002 described herein. In such an embodiment, the application or web service of the authentication service 1040 may be provided by a financial services system (e.g., a bank, a transaction processing system, an inventory management system, or some other such financial services system). In an embodiment, elements of the authentication service 1040 are running on an auxiliary device or system configured to execute tasks associated with the authentication service 1040 (e.g., provides authentication using payment instrument processing device attached to a smart phone or tablet). In an embodiment, elements of the authentication service 1040 are running on virtual device such as those described herein. Although not illustrated here, in an embodiment, the authentication service 1040 may be running on one or more of a plurality of devices that may be interconnected using a network such as the network 1022.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1002) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 800 for generating pre-qualification offers for new lines of credit illustrated in FIG. 8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1002.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving a pre-qualification request associated with a user, wherein the pre-qualification request includes information corresponding to the user;
obtaining a credit evaluation corresponding to the user, wherein the credit evaluation is obtained based on the information corresponding to the user;
training a machine learning algorithm to identify a set of payment instruments that the user is pre-qualified for, wherein the machine learning algorithm is trained using the information, the credit evaluation, historical data, and issued payment instruments;
providing a set of offers corresponding to the set of payment instruments that the user is pre-qualified for;
receiving an application for a payment instrument from the set of payment instruments, wherein the application corresponds to a selection of an offer from the set of offers; and
updating the machine learning algorithm, wherein the machine learning algorithm is updated using the set of offers, the selection of the offer from the set of offers, the historical data, and the issued payment instruments.

2. The computer-implemented method of claim 1, further comprising:
determining that the user is approved for the payment instrument, wherein the user is approved for the payment instrument based on the application and the credit evaluation; and
providing an alternative set of offers corresponding to other payment instruments, wherein the alternative set of offers includes a set of incentives for selecting an offer from the alternative set of offers, and wherein the set of incentives are determined based on the information corresponding to the user and the credit evaluation.

3. The computer-implemented method of claim 1, further comprising:
submitting a soft credit inquiry to obtain the credit evaluation, wherein the soft credit inquiry includes the information corresponding to the user.

4. The computer-implemented method of claim 1, further comprising:
automatically tracking credit performances associated with the user and other users, wherein the credit performances correspond to usage of the payment instrument and to usage of other payment instruments issued to the other users, and wherein the credit performances are tracked in real-time; and
updating the machine learning algorithm using the credit performances.

5. The computer-implemented method of claim 1, wherein the set of offers include an offer corresponding to a secured dual-feature payment instrument, and wherein the offer indicates a security deposit for the secured dual-feature payment instrument.

6. The computer-implemented method of claim 1, wherein the set of offers include details corresponding to benefits and terms associated with the set of payment instruments.

7. The computer-implemented method of claim 1, further comprising:
receiving another application for an alternative payment instrument, wherein the alternative payment instrument does not correspond to the set of offers; and
updating the machine learning algorithm using the other application for the alternative payment instrument.

8. The computer-implemented method of claim 1, wherein the historical data and the issued payment instruments correspond to the user.

9. The computer-implemented method of claim 1, wherein the historical data and the issued payment instruments correspond to other users.

10. A system, comprising:
one or more processors; and
memory storing thereon instructions that, as a result of being executed by the one or more processors, cause the system to:
receive a pre-qualification request associated with a user, wherein the pre-qualification request includes information corresponding to the user;
obtain a credit evaluation corresponding to the user, wherein the credit evaluation is obtained based on the information corresponding to the user;
train a machine learning algorithm to identify a set of payment instruments that the user is pre-qualified for, wherein the machine learning algorithm is trained using the information, the credit evaluation, historical data, and issued payment instruments;
provide a set of offers corresponding to the set of payment instruments that the user is pre-qualified for;
receive an application for a payment instrument from the set of payment instruments, wherein the application corresponds to a selection of an offer from the set of offers; and
update the machine learning algorithm, wherein the machine learning algorithm is updated using the set of offers, the selection of the offer from the set of offers, the historical data, and the issued payment instruments.

11. The system of claim 10, wherein the instructions further cause the system to:
determine that the user is approved for the payment instrument, wherein the user is approved for the payment instrument based on the application and the credit evaluation; and
provide an alternative set of offers corresponding to other payment instruments, wherein the alternative set of offers includes a set of incentives for selecting an offer from the alternative set of offers, and wherein the set of incentives are determined based on the information corresponding to the user and the credit evaluation.

12. The system of claim 10, wherein the instructions that cause the system to obtain the credit evaluation further cause the system to:
submit a soft credit inquiry to obtain the credit evaluation, wherein the soft credit inquiry includes the information corresponding to the user.

13. The system of claim 10, wherein the instructions further cause the system to:
automatically track credit performances associated with the user and other users, wherein the credit performances correspond to usage of the payment instrument and to usage of other payment instruments issued to the other users, and wherein the credit performances are tracked in real-time; and
update the machine learning algorithm using the credit performances.

14. The system of claim 10, wherein the set of offers include an offer corresponding to a secured dual-feature payment instrument, and wherein the offer indicates a security deposit for the secured dual-feature payment instrument.

15. The system of claim 10, wherein the set of offers include details corresponding to benefits and terms associated with the set of payment instruments.

16. The system of claim 10, wherein the instructions further cause the system to:
receive another application for an alternative payment instrument, wherein the alternative payment instrument does not correspond to the set of offers; and
update the machine learning algorithm using the other application for the alternative payment instrument.

17. The system of claim 10, wherein the historical data and the issued payment instruments correspond to the user.

18. The system of claim 10, wherein the historical data and the issued payment instruments correspond to other users.

19. A non-transitory, computer-readable storage medium storing thereon executable instructions that, as a result of being executed by one or more processors of a computer system, cause the computer system to:
receive a pre-qualification request associated with a user, wherein the pre-qualification request includes information corresponding to the user;
obtain a credit evaluation corresponding to the user, wherein the credit evaluation is obtained based on the information corresponding to the user;
train a machine learning algorithm to identify a set of payment instruments that the user is pre-qualified for, wherein the machine learning algorithm is trained using the information, the credit evaluation, historical data, and issued payment instruments;
provide a set of offers corresponding to the set of payment instruments that the user is pre-qualified for;
receive an application for a payment instrument from the set of payment instruments, wherein the application corresponds to a selection of an offer from the set of offers; and
update the machine learning algorithm, wherein the machine learning algorithm is updated using the set of offers, the selection of the offer from the set of offers, the historical data, and the issued payment instruments.

20. The non-transitory, computer-readable storage medium of claim 19, wherein the executable instructions further cause the computer system to:
determine that the user is approved for the payment instrument, wherein the user is approved for the payment instrument based on the application and the credit evaluation; and
provide an alternative set of offers corresponding to other payment instruments, wherein the alternative set of offers includes a set of incentives for selecting an offer from the alternative set of offers, and wherein the set of incentives are determined based on the information corresponding to the user and the credit evaluation.

21. The non-transitory, computer-readable storage medium of claim 19, wherein the executable instructions that cause the computer system to obtain the credit evaluation further cause the computer system to:
submit a soft credit inquiry to obtain the credit evaluation, wherein the soft credit inquiry includes the information corresponding to the user.

22. The non-transitory, computer-readable storage medium of claim 19, wherein the executable instructions further cause the computer system to:
automatically track credit performances associated with the user and other users, wherein the credit performances correspond to usage of the payment instrument and to usage of other payment instruments issued to the other users, and wherein the credit performances are tracked in real-time; and
update the machine learning algorithm using the credit performances.

23. The non-transitory, computer-readable storage medium of claim 19, wherein the set of offers include an offer corresponding to a secured dual-feature payment instrument, and wherein the offer indicates a security deposit for the secured dual-feature payment instrument.

24. The non-transitory, computer-readable storage medium of claim 19, wherein the set of offers include details corresponding to benefits and terms associated with the set of payment instruments.

25. The non-transitory, computer-readable storage medium of claim 19, wherein the executable instructions further cause the computer system to:
receive another application for an alternative payment instrument, wherein the alternative payment instrument does not correspond to the set of offers; and
update the machine learning algorithm using the other application for the alternative payment instrument.

26. The non-transitory, computer-readable storage medium of claim 19, wherein the historical data and the issued payment instruments correspond to the user.

27. The non-transitory, computer-readable storage medium of claim 19, wherein the historical data and the issued payment instruments correspond to other users.
